(19) United States
(12) Patent Application Publication
(10) Pub. No.: US 2021/0131970 A1
(43) Pub. Date: May 6, 2021

(54) ANALYSIS SUBSTRATE AND PRODUCTION METHOD THEREOF

(71) Applicant: Oji Holdings Corporation, Tokyo (JP)

(72) Inventors: Kei SHINOTSUKA, Tokyo (JP); Kotaro DAI, Tokyo (JP); Shogo MIURA, Tokyo (JP)

(21) Appl. No.: 16/963,160

(22) PCT Filed: Jan. 24, 2019
(86) PCT No.: PCT/JP2019/002276

§ 371 Date: Jul. 17, 2020

(30) Foreign Application Priority Data
Jan. 25, 2018 (JP) 2018-010682

(51) Int. Cl. G01N 21/65; G01N 21/64; G01N 21/35

(52) U.S. Cl. CPC G01N 21/658; B82Y 30/00; G01N 21/35; G01N 21/64

(57) ABSTRACT

An analysis substrate including a substrate having at least a first surface made of a dielectric or a semiconductor, and a metal film provided on the first surface of the substrate, wherein the metal film has multiple non-deposition areas which are provided as an island-like gap shape having a length of 1 μm or less in a long axis direction in the metal film and in which there is no metal and the first surface is exposed, wherein the sheet resistance of a surface of the metal film at 25° C. is 3 to 5,000Ω/□.

### TECHNICAL FIELD

The present invention relates to an analysis substrate and a production method thereof.

Priority is claimed on Japanese Patent Application No. 2018-010682, filed Jan. 25, 2018, the content of which is incorporated herein by reference.

### BACKGROUND ART

In recent years, Raman spectroscopic methods have been problematic because the intensity of Raman scattered light is extremely weak. For improvement, utilization of surface enhanced Raman scattering (SERS) has been examined. SERS is a phenomenon in which, on a surface made of a metal such as Au or Ag, the intensity of Raman scattered light of an adsorbed measurement target molecule is significantly enhanced according to electric field enhancement due to surface plasmon resonance. Utilization of electric field enhancement due to surface plasmon resonance has been examined in optical analysis methods for infrared absorption spectroscopy and fluorescence spectroscopy in addition to Raman spectroscopic methods.

Regarding an analysis substrate using electric field enhancement due to surface plasmon resonance, for example, the following has been proposed.

(1) A signal amplifying device for Raman spectroscopic analysis including a substrate having a nano periodic structure in which a plurality of depressions or a plurality of protrusions are arranged in a lattice pattern at predetermined specific lattice intervals and surface plasmon resonance occurs, and a metal film formed on a surface of the nano periodic structure (Patent Document 1).
(2) An electric field enhancement element including a metal layer, a dielectric layer provided on the metal layer, and a plurality of metal particles provided on the dielectric layer, wherein the plurality of metal particles have a periodic array in which a propagation type surface plasmon that propagates through an interface between the metal layer and the dielectric layer can be excited, the propagation type surface plasmon electromagnetically interacts with a localized surface plasmon excited by the metal particles, the surface plasmons have different resonance wavelengths, in a reflected light spectrum when white light is emitted to the electric field enhancement element, half-value widths of a first absorption area and a second absorption area satisfy a specific relationship, and a wavelength of excitation light of the electric field enhancement element is included in a range of the second absorption area (Patent Document 2).

### CITATION LIST

### Patent Literature

### [Patent Document 1]

Japanese Unexamined Patent Application, First Publication No. 2015-232526

### [Patent Document 2]

Japanese Unexamined Patent Application, First Publication No. 2015-212626

### SUMMARY OF INVENTION

### Technical Problem

However, the analysis substrates (1) to (2) may not have sufficient sensitivity.

In the device in Patent Document 1, since the propagation type surface plasmon is used, there is an advantage that the variation in the electric field distribution on the nano periodic structure is small, but there is a disadvantage that the enhancement effect is weak because electric field enhancement depends on only the propagation type surface plasmon.

On the other hand, in the electric field enhancement element in Patent Document 2, when the propagation type surface plasmon and the localized surface plasmon are combined, the electric field distribution is made uniform with the propagation type surface plasmon, and the electric field intensity is increased with the localized surface plasmon, the advantages of the propagation type and the localized type are combined and it is possible to achieve a configuration having both the uniformity and the intensity to some extent. However, there is a disadvantage that, since the dielectric layer is provided between the metal layer and metal particles, measurement target molecules of a specimen cannot approach the surface of the metal film having the strongest electric field enhancement effect of the propagation type surface plasmon. In addition, there is a disadvantage that, since metal particles are arranged in the arrangement necessary to excite the propagation type surface plasmon, a distance between particles becomes too large when electric field enhancement using a gap between metal particles having a strong effect for the localized surface plasmon is used.

An object of the present invention is to provide an analysis substrate which enables optical analysis using electric field enhancement due to surface plasmon resonance with high sensitivity and a production method thereof.

### Solution to Problem

The present invention includes the following aspects.

[1] An analysis substrate including a substrate having at least a first surface made of a dielectric or a semiconductor, and a metal film provided on the first surface of the substrate, wherein the metal film has a plurality of non-deposition areas which are provided as an island-like gap shape having a length of 1 μm or less in a long axis direction in the metal film and in which there is no metal and the first surface is exposed; and wherein the sheet resistance of a surface of the metal film at 25° C. is 3 to 5,000Ω/□.
[2] The analysis substrate according to [1], wherein the sheet resistance of the surface of the metal film at 25° C. is 3 to 500Ω/□.
[3] The analysis substrate according to [1], wherein the sheet resistance of the surface of the metal film at 25° C. is 3 to 300Ω/□.
[4] The analysis substrate according to any one of [1] to [3], further including a plurality of metal nanoparticles having an average primary particle diameter of 5 to 100 nm that are distributed and arranged on the metal film.
[5] The analysis substrate according to any one of [1] to [3], wherein the first surface of the substrate has a periodic uneven structure.
[6] The analysis substrate according to any one of [1] to [3], wherein the first surface of the substrate has a periodic uneven structure, and wherein a plurality of metal nanoparticles having an average primary particle diameter of 5 to 100 nm are distributed and arranged on the metal film.
[7] An analysis substrate including a substrate having at least a first surface made of a dielectric or a semiconductor, a metal film provided on the first surface of the substrate, and a plurality of metal nanoparticles which are distributed and arranged on the metal film and have an average primary particle diameter of 5 to 100 nm, wherein the metal film has a plurality of non-deposition areas which are provided as an island-like gap shape having a length of 1 μm or less in a long axis direction in the metal film and in which there is no metal and the first surface is exposed; and wherein the sheet resistance of a surface of the metal film at 25° C. exceeds 5,000Ω/□.
[8] A method of producing an analysis substrate, including a process of depositing a metal on a first surface of a substrate having at least the first surface made of a dielectric or a semiconductor to form a metal film, wherein, in the process of forming the metal film, when a plurality of areas in which no metal is deposited remain on the first surface as an island-like gap shape having a length of 1 μm or less in a long axis direction, and the sheet resistance of a surface of the metal film at 25° C. is 3 to 5,000Ω/□, deposition of the metal on the first surface ends.
[9] The method of producing an analysis substrate according to [8], wherein, when deposition of the metal on the first surface ends, the sheet resistance of the surface of the metal film at 25° C. is 3 to 500Ω/□.
[10] The method of producing an analysis substrate according to [8], wherein, when deposition of the metal on the first surface ends, the sheet resistance of the surface of the metal film at 25° C. is 3 to 300Ω/□.
[11] The method of producing an analysis substrate according to any one of [8] to [10], wherein the first surface of the substrate has a periodic uneven structure.
[12] The method of producing an analysis substrate according to any one of [8] to [10], further including a process of applying a metal nano particle dispersion solution containing a plurality of metal nanoparticles having an average primary particle diameter of 5 to 100 nm and a dispersion medium to the metal film and performing drying.
[13] The method of producing an analysis substrate according to any one of [8] to [10], further including a process of applying a metal nano particle dispersion solution containing a plurality of metal nanoparticles having an average primary particle diameter of 5 to 100 nm and a dispersion medium to the metal film and performing drying, wherein the first surface of the substrate has a periodic uneven structure.

### Advantageous Effects of Invention

According to the present invention, it is possible to provide an analysis substrate which enables optical analysis using electric field enhancement due to surface plasmon resonance with high sensitivity and a production method thereof.

In particular, the clear difference from Patent Document 2 is that, in the present invention, measurement target molecules of a specimen can approach the surface of the metal film having the strongest electric field enhancement effect of the propagation type surface plasmon. Due to this difference, the present invention has a more excellent enhancement effect of Raman scattered light than the related art.

### BRIEF DESCRIPTION OF DRAWINGS

FIG. 1 is a cross-sectional view schematically showing an analysis substrate according to a first embodiment of the present invention.

FIG. 2 is an enlarged top view schematically showing a surface of the analysis substrate according to the first embodiment on the side of a metal film.

FIG. 3 is a partial cross-sectional view schematically showing a cross section of the analysis substrate according to the first embodiment along III-III in FIG. 2.

FIG. 4 is a cross-sectional view schematically showing an analysis substrate according to a second embodiment of the present invention.

FIG. 5 is a cross-sectional view schematically showing an analysis substrate according to a third embodiment of the present invention.

FIG. 6 is a top view schematically showing an analysis substrate according to an example of the third embodiment.

FIG. 7 is a perspective view of the analysis substrate shown in FIG. 6.

FIG. 8 is a cross-sectional view schematically showing an analysis substrate according to a fourth embodiment of the present invention.

FIG. 9 is a scanning electron microscope image of an analysis substrate obtained in Example 1.

FIG. 10 is a scanning electron microscope image of an analysis substrate obtained in Example 3.

FIG. 11 is a scanning electron microscope image of an analysis substrate obtained in Example 4.

FIG. 12 is a scanning electron microscope image of an analysis substrate obtained in Comparative Example 3.

### DESCRIPTION OF EMBODIMENTS

Hereinafter, an analysis substrate and a production method thereof according to embodiments of the present invention will be described with reference to the appended drawings.

### First Embodiment

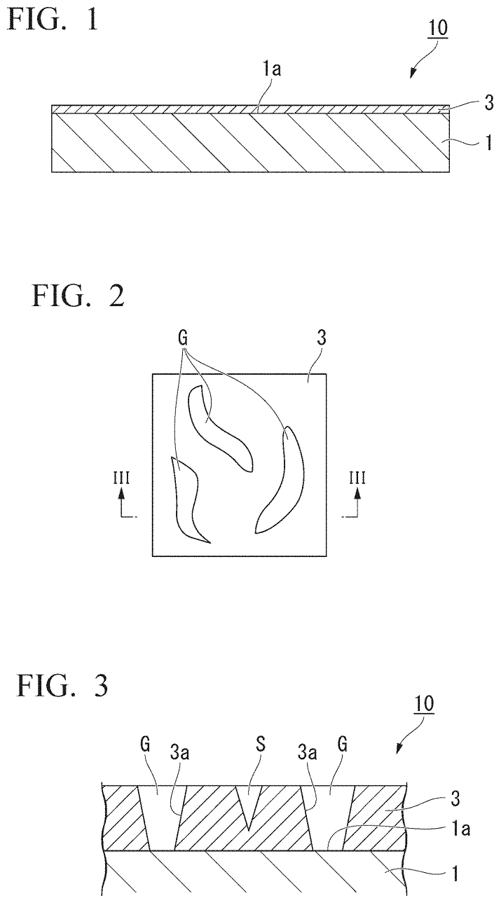

FIG. 1 is a cross-sectional view schematically showing an analysis substrate according to a first embodiment of the present invention, FIG. 2 is an enlarged top view schematically showing a surface on the side of a metal film of the present embodiment, and FIG. 3 is a partial cross-sectional view schematically showing a cross section of the analysis substrate according to the present embodiment along III-III in FIG. 2.

An analysis substrate 10 according to the present embodiment includes a substrate 1 and a metal film 3 provided on a first surface 1a of the substrate 1.

(Substrate)

In the substrate 1, at least the first surface 1a is made of a dielectric or a semiconductor.

The substrate 1 may be, for example, a substrate made of a dielectric or a semiconductor or may be a multi-layer substrate in which two or more layers of a conductor layer, a dielectric layer, and a semiconductor layer are laminated so that the first surface is made of a dielectric or a semiconductor. The dielectric or semiconductor is not particularly limited, and may be a known material for applications such as an analysis substrate.

Regarding the substrate 1, a substrate made of only a dielectric or a semiconductor is typically used, and examples thereof include a quartz substrate, various glass substrates such as alkali glass and non-alkali glass, a sapphire substrate, a silicon (Si) substrate, a substrate made of an inorganic substance such as silicon carbide (SiC), and a substrate made of an organic substance such as a polymethylmethacryate, polycarbonate, polystyrene, a polyolefin resin or a polyester resin.

The thickness of the substrate 1 is not particularly limited, and may be, for example, 0.1 to 5.0 mm.

(Metal Film)

The metal constituting the metal film 3 may be any metal that can cause electric field enhancement due to surface plasmon resonance, and examples thereof include gold, silver, aluminum, copper, platinum, and alloys of two or more thereof.

The metal film 3 has a plurality of non-deposition areas G. The plurality of non-deposition areas G are distributed and provided as an island-like gap shape having a length of 1 μm or less in the long axis direction in the metal film 3. The area of the metal film 3 other than the non-deposition areas G is a deposition area.

The non-deposition areas G are areas in which there is no metal and the first surface 1a is exposed, that is, voids (gaps) that penetrate the metal film 3 in the thickness direction. The area (for example, an area S in FIG. 3) that does not form a void penetrating the metal film 3 even if the metal is not present in a part in the thickness direction is a deposition area that does not correspond to the non-deposition areas G.

The non-deposition areas G are an island-like gap in a top view, and the plurality of non-deposition areas G may be independent from each other or may be connected to each other, but are not connected as a whole. Therefore, as shown in FIG. 3, the non-deposition areas G are surrounded by metal surfaces 3a, and the metal surfaces 3a face each other with the non-deposition areas G therebetween. The distance between metal surfaces facing each other with the non-deposition areas G therebetween, that is, the width of the non-deposition areas G, is generally extremely small, for example, in the order of several nanometers to several tens of nanometers. Between such metal surfaces 3a, electric field enhancement can occur by superimposition of electric fields due to a localized surface plasmon. In particular, when the width of the non-deposition areas G is less than 10 nanometers, very strong electric field enhancement can be obtained.

The distance between the metal surfaces 3a facing each other with the non-deposition areas G therebetween is preferably 1 to 20 nm, more preferably 1 to 10 nm, and still more preferably 1 to 5 nm. When the distance between the metal surfaces 3a is within the above range, the electric field enhancement effect due to localized surface plasmon resonance is more excellent.

As shown in FIG. 3, when the metal surface surrounding the non-deposition areas G is an inclined surface inclined in the thickness direction of the metal film 3, there is a distribution in the distance between the metal surfaces 3a. When there is a distribution in the distance between the metal surfaces 3a, preferably, the maximum value of the distance between the metal surfaces 3a is a preferable upper limit value or less. In addition, preferably, the minimum value of the distance between the metal surfaces 3a is a preferable lower limit value or more.

The distance between the metal surfaces 3a is measured by a method described in examples to be described below.

The sheet resistance of the surface of the metal film 3 at 25° C. (hereinafter “sheet resistance of the surface at 25° C.” may be simply referred to as “sheet resistance of the surface”) is 3 to 5,000Ω/□, preferably 3 to 500Ω/□, and most preferably 3 to 300Ω/□. The sheet resistance of the surface of the metal film 3 within this range indicates that the metal film 3 is a continuous film which has a nanogap due to the non-deposition areas G but is not completely divided. In addition, the sheet resistance of the surface of the metal film 3 within this range means that the distance between the metal surfaces 3a facing each other with the non-deposition areas G therebetween is in a range of 1 to 20 nm, more specifically, in a range of 1 to 10 nm, and still more specifically in a range of 1 to 5 nm. When the metal film 3 is a discontinuous film (for example, composed of a plurality of metal films distributed and arranged in an island shape), the sheet resistance of the surface does not become 5,000Ω/□ or less. Since the metal film 3 partially has the non-deposition areas G but is a continuous film as a whole, the metal film 3 can induce a propagation type surface plasmon to be described below, and it is easy to obtain a non-linear optical effect by superimposition of surface electric fields.

The sheet resistance (Ω/□) of the surface of the metal film 3 is a value at 25° C. Specifically, the electrical resistance value (Ω) when a current flows from one end to the opposite end in a square area having an arbitrary size on the surface of the metal film 3 under conditions of 25° C. is the sheet resistance of the surface of the metal film at 25° C. Details are as shown in examples to be described below.

Regarding the thickness of the metal film 3, the average thickness of the area other than the non-deposition areas G, that is, the deposition area, is preferably 3 to 30 nm, more preferably 4 to 25 nm, and most preferably 5 to 20 nm. When the thickness of the metal film 3 is within the above range, the metal film 3 which has the non-deposition areas G and in which a distance between metal surfaces facing each other with the non-deposition areas G therebetween, and a proportion of the area of the non-deposition areas G with respect to the total area of the metal film 3 are within the preferable ranges is likely to be obtained. When the thickness of the metal film 3 is the lower limit value or larger, the sheet resistance of the surface of the metal film 3 is likely to be the upper limit value or less.

The thickness of the metal film 3 (the average thickness of the deposition area) is a value calculated from the film formation rate obtained by the following method. First, a flat base material having a centerline average roughness Ra of 1 nm or less determined under an atomic force microscope (AFM) such as a single crystal silicon substrate is prepared and masked with a tape or the like, and a metal film of about several nm to several tens of nm is then formed for a certain time, the mask is removed, and the film formation thickness is then measured under the AFM. According to the information, the film formation rate (film formation thickness (nm/min) per unit time) is obtained. When the film formation rate is obtained, the thickness of the metal film 3 can be calculated from the film formation rate and the film formation time for which the metal film 3 is formed.

In the above method, for convenience, the film formation thickness may be measured using a stylus profilometer in place of the AFM. In this case, although the same results are obtained, when the measured values obtained by the AFM and the stylus profilometer are different, the measured value obtained by the AFM is used in the present invention.

For convenience, the thickness of the metal film 3 may be measured using a method in which a transmission electron microscope (TEM) is used, a microscopic image of a cross-sectional sample of a substrate including the metal film 3 is obtained, and the thickness of the metal film 3 in the image is actually measured. In this case, the same results are obtained. This method is effective for a sample whose production conditions and the like are unknown because there is no need to measure information about a film formation rate and the like in advance.

Regarding another method for ascertaining the thickness of the metal film 3 of a sample whose film formation rate is unknown, a method in which extremely fine scratches are formed on the surface of the metal film 3 using a knife or the like and the depth of the scratches is measured by the AFM is effective. Since the metal film 3 is extremely thin, it is possible to form scratches through which the base material is exposed with a relatively weak force.

(Method of Producing Analysis Substrate)

Examples of a method of producing the analysis substrate 10 include the following production method (I).

Production Method (I):

A method of producing an analysis substrate including a process of depositing a metal on the first surface 1a of the substrate 1 to form the metal film 3, and in the process of forming the metal film 3, when a plurality of areas in which no metal is deposited remain on the first surface 1a as an island-like gap shape having a length in the long axis direction of 1 μm or less, and the sheet resistance of the surface of the metal film 3 is 3 to 5,000Ω/□, deposition of the metal on the first surface 1a ends.

Here, when deposition of a metal continues without ending, the non-deposition areas G disappear, irregularities on the film surface are reduced, and the metal film has a flat surface.

A method of depositing a metal on the first surface 1a is not particularly limited, and examples thereof include a dry method such as a vapor deposition method and a wet method such as electrolytic plating or electroless plating. Examples of dry methods include various vacuum sputtering methods, a physical vapor deposition method (PVD) such as a vacuum deposition method, and various chemical vapor deposition (CVD) methods.

When a metal film is formed (a metal is deposited) on the first surface 1a by a dry method, first, a plurality of metal particles adhere to the entire first surface 1a, and the metal particles grow and bond to each other to form a plurality of fine land-like metal films. As film formation progresses, adjacent metal films form larger clusters, and the area and thickness of the metal film increase. Accordingly, an area in which no metal is deposited on the first surface 1a becomes narrower. If film formation ends when the area in which no metal is deposited remains in an island shape and the value of the sheet resistance of the surface of the formed metal film is within the above range (when the metal film is a continuous film), the above metal film 3 is obtained. The area which remains in an island shape and in which no metal is deposited becomes the non-deposition areas G.

When a catalyst is distributed and arranged on the first surface 1a in advance, and a metal film is formed by electroless plating in that state, first, a metal adheres to the periphery of the catalyst to form a plurality of fine island-like metal films. As electroless plating progresses, as in the dry method, metal films form larger clusters, and an area in which no metal is deposited on the first surface 1a becomes narrower. If film formation ends when the area in which no metal is deposited remains in an island shape and the value of the sheet resistance of the surface of the formed metal film is within the above range, the above metal film 3 is obtained. The area which remains in an island shape and in which no metal is deposited becomes the non-deposition areas G.

Regarding a method of depositing a metal on the first surface 1a, the sputtering method is preferable because impurities are unlikely to adhere, the adhesion strength of the metal film with respect to the base material is high, and it is easy to control the sea-island structure. That is, the metal film 3 is preferably a film formed by the sputtering method.

A plurality of areas in which no metal is deposited that remain in an island shape on the first surface 1a can be confirmed by surface observation using a microscope device with a high magnification of about 100,000 such as an atomic force microscope (AFM) and a scanning electron microscope (SEM).

The sheet resistance of the surface of the metal film 3 when vapor deposition ends is preferably 3 to 500Ω/□ and most preferably 3 to 300Ω/□.

After the process of forming the metal film 3, when the film is stored for a long time under a general environment (in air), there is a risk of contaminants in air adhering to a metal structure on the surface of the substrate and reducing the effects of the present invention. Therefore, the film is preferably stored in a vacuum container or in an inert gas such as nitrogen or argon. When the effects of the present invention are reduced by contaminants in air, as necessary, the surface of the same substrate may be treated with ultraviolet (UV)/ozone or the like in order to restore its function.

(Operations and Effects)

When the analysis substrate 10 of the present embodiment is used for spectroscopic measurement, localized surface plasmon resonance due to incident light occurs in the non-deposition areas G of the metal film 3, a non-linear optical electric field enhancement effect due to superimposition of electric fields can be obtained, and optical analysis using the electric field enhancement effect can be performed with high sensitivity.

The analysis substrate 10 also has excellent productivity. For example, as shown in the production method (I), it can be produced by simply depositing a metal on a substrate. In addition, there is no need to use a large amount of metal to form a structure that can cause the electric field enhancement due to localized surface plasmon resonance, and raw material costs can be reduced.

According to the above effects, the analysis substrate 10 is useful for optical analysis using the electric field enhancement effect due to surface plasmon resonance.

Examples of such optical analysis methods include a Raman spectroscopic analysis method, an infrared spectroscopic method, and fluorescence analysis. Among these, the Raman spectroscopic analysis method is suitable.

The Raman spectroscopic analysis method is an analysis method in which Raman scattering in which only vibration energy of a molecule is shifted with respect to incident light when light is emitted to a sample is observed, and the structure at a molecular level is analyzed. Like the infrared spectrum obtained by the infrared spectroscopic method, the obtained Raman spectrum is a vibration spectrum based on vibration of molecules, the vertical axis represents scattering intensity (Intensity), and the horizontal axis represents Raman shift (cm⁻¹). In the Raman spectroscopic analysis method and the infrared spectroscopic analysis method, vibration modes of the same functional group are detected with the same wave number, but unlike the infrared spectroscopic analysis method, since a water sample can be measured in the Raman spectroscopic analysis method, there is an advantage that there is no need to perform a pretreatment on a sample for analysis such as a biological sample and a food sample. However, a general Raman spectroscopic analysis method without performing surface electric field enhancement has a disadvantage that the intensity of Raman scattered light is extremely weak.

A surface enhanced Raman spectroscopic analysis method is a Raman spectroscopic analysis method using SERS. In the analysis substrate 10, since the Raman scattering (Stokes scattering and anti-Stokes scattering) intensity of molecules adsorbed on the surface of the analysis substrate 10 can be significantly enhanced due to the SERS effect, spectroscopic analysis with high sensitivity is possible. Actually, it is possible to detect a substance-specific spectrum with a trace amount of a dilute specimen, which is useful for environmental measurement, measurement of a trace amount of a biomarker, and detection of biological and chemical weapons.

### Second Embodiment

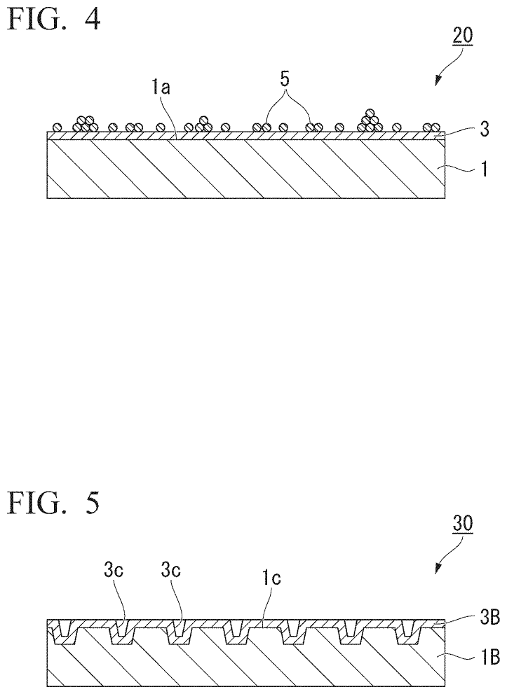

FIG. 4 is a cross-sectional view schematically showing an analysis substrate according to a second embodiment of the present invention. Here, in the following embodiment, components corresponding to those in the first embodiment will be denoted with the same reference numerals and detailed descriptions thereof will be omitted. An analysis substrate 20 of the present embodiment includes the substrate 1, the metal film 3 provided on the first surface 1a of the substrate 1, and a plurality of metal nanoparticles 5 that are distributed and arranged on the metal film 3. The metal film 3 and the plurality of metal nanoparticles 5 are in contact with each other.

The analysis substrate 20 is the same as the analysis substrate 10 of the first embodiment except that it further includes the plurality of metal nanoparticles 5.

(Metal Nanoparticles)

The metal constituting the metal nanoparticles 5 may be any metal that can cause electric field enhancement due to surface plasmon resonance, and examples thereof include gold, silver, aluminum, copper, platinum, and alloys of two or more thereof.

The shape of the metal nanoparticles 5 is not particularly limited, and examples thereof include a spherical shape, a needle shape (bar shape), a flake shape, a polyhedral shape, a ring shape, a hollow shape (a hollow part or a dielectric is present in a center part), a dendritic crystal, and other irregular shapes.

At least some of the plurality of metal nanoparticles 5 may aggregate to form secondary particles.

The average primary particle diameter of the metal nanoparticles 5 is 5 to 100 nm, preferably 5 to 80 nm, and more preferably 5 to 40 nm. When the average primary particle diameter of the metal nanoparticles 5 is within the above range, the electric field enhancement effect due to localized surface plasmon resonance is excellent.

The average primary particle diameter of the metal nanoparticles 5 is measured by a method in which primary particle diameters of the metal nanoparticles 5 are directly measured under a scanning electron microscope (SEM) and an average value thereof is obtained. In this case, in order to ascertain the average state, an average value of n=20 or more is obtained.

In the above method, for convenience, a transmission electron microscope (TEM) or an atomic force microscope (AFM) may be used in place of the SEM. In this case, the same results are obtained.

For convenience, the average primary particle diameter of the metal nanoparticles 5 may be measured by a particle diameter distribution meter using a dynamic light scattering method. In this case, when there are secondary particles (an aggregate in which primary particles are aggregated), since a plurality of peaks occur in a particle diameter distribution curve, the peak of the smallest particle diameter is a desired particle diameter. In this method, the same results as in the measurement method using the SEM can be obtained.

The measurement method using a microscopic device such as an SEM is useful when the surface of the analysis substrate as a product is analyzed later, and the measurement method using a dynamic light scattering method is useful when the analysis substrate is produced.

The shortest distance between two adjacent metal nanoparticles 5 that are arranged apart from each other on the metal film 3 is preferably 1 to 20 nm, more preferably 1 to 10 nm, and still more preferably 1 to 5 nm. When the shortest distance is within the above range, electric field enhancement due to localized surface plasmon resonance occurs between the metal nanoparticles 5, Raman spectroscopic analysis with high sensitivity of measurement target molecules adsorbed between the metal nanoparticles 5 is possible. In addition, even if the metal nanoparticles 5 are grounded in the metal film 3, since a small gap between the metal film 3 and the metal nanoparticles 5 is generated in the vicinity of the contact, electric field enhancement due to localized surface plasmon resonance also occurs here, and Raman spectroscopic analysis with high sensitivity is possible.

The shortest distance is measured by a method in which a microscopic image of a surface sample of a substrate containing two adjacent metal nanoparticles is obtained using a scanning electron microscope (SEM), and a gap between two adjacent metal nanoparticles in the image is actually measured. In this method, a magnification of 100,000 or more and preferably 1,000,000 or more is required. Since the shortest distance between two adjacent metal nanoparticles 5 locally differs and is not uniform, measurement is performed at n=20 or more to obtain a distance distribution.

In the above method, for convenience, a transmission electron microscope (TEM) or an atomic force microscope (AFM) may be used in place of the SEM. In this case, the same results are obtained.

However, it is said that a nanogap of about 1 nm most effectively contributes to the surface enhanced Raman scattering effect, and the average value of distance distributions is not necessarily a meaningful value.

(Method of Producing Analysis Substrate)

Examples of a method of producing the analysis substrate 20 include the following production method (II).

Production Method (II):

A method of producing an analysis substrate including a process of depositing a metal on the first surface 1a of the substrate 1 to form the metal film 3, and a process of applying a metal nano particle dispersion solution containing the plurality of metal nanoparticles 5 and a dispersion medium onto the metal film 3 and performing drying, and in the process of forming the metal film 3, when a plurality of areas in which no metal is deposited on the first surface 1a remain in an island shape, and the sheet resistance of the surface of the metal film 3 is 3 to 5,000Ω/□, deposition of the metal on the first surface 1a ends.

The process of forming the metal film 3 is the same as the process of forming the metal film 3 in the production method (I) and the preferable embodiment is also the same.

The dispersion medium of the metal nano particle dispersion solution may be any medium in which the metal nanoparticles 5 can disperse, and examples thereof include water, ethanol, and other organic solvents.

The content of the metal nanoparticles 5 in the metal nano particle dispersion solution may be, for example, 0.01 to 10.0 mass % and preferably 0.1 to 1.0 mass % with respect to a total mass of the metal nano particle dispersion solution.

The metal nano particle dispersion solution may further contain citric acid as a dispersion stabilizer and various inorganic salts and the like as necessary as long as the effects of the invention are not impaired.

The method of applying a metal nano particle dispersion solution is not particularly limited, and for example, can be appropriately selected from among known coating methods such as a spraying method, a drop-casting method, a dip coating method, a spin coating method, and an inkjet printing method. The spraying method or the inkjet printing method is preferable because metal nanoparticles can be uniformly arranged with a high density on the surface of the substrate by dispersing metal nanoparticles.

(Operations and Effects)

When the analysis substrate 20 of the present embodiment is used for spectroscopic measurement, localized surface plasmon resonance due to incident light occurs in the non-deposition areas G of the metal film 3, between the metal film 3 and the metal nanoparticles 5, and between the adjacent metal nanoparticles 5, a non-linear optical electric field enhancement effect due to superimposition of electric fields can be obtained. According to three types of localized surface plasmon resonance, optical analysis using the electric field enhancement effect can be performed with higher sensitivity than in the first embodiment.

In addition, in a part in which localized surface plasmon resonance in the non-deposition areas G of the metal film 3 and localized surface plasmon resonance between the adjacent metal nanoparticles 5 overlap, an electric field enhancement effect with higher sensitivity than the electric field enhancement effect according to the above three types of localized surface plasmon resonance can be obtained, and optical analysis using electric field enhancement can be performed with higher sensitivity than in the first embodiment.

The analysis substrate 20 also has excellent productivity. For example, as shown in the production method (II), it can be produced by simply depositing a metal on a substrate, and additionally applying a metal nano particle dispersion solution and performing drying. In addition, there is no need to use a large amount of metal for forming a structure that can cause electric field enhancement due to localized surface plasmon resonance and raw material cost can be reduced.

According to the above effects, the analysis substrate 20 is useful for optical analysis using the electric field enhancement effect due to surface plasmon resonance. Examples of such an optical analysis method include the same as those described above.

### Third Embodiment

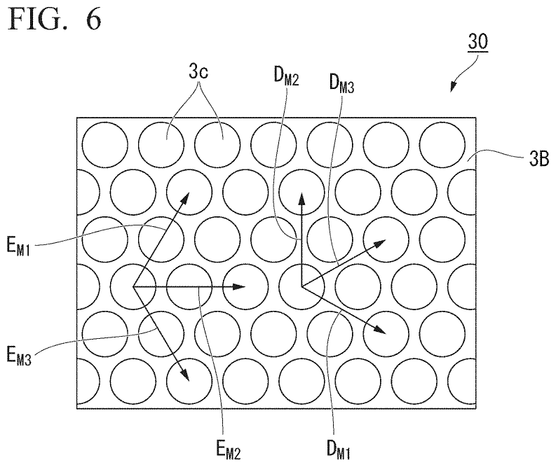

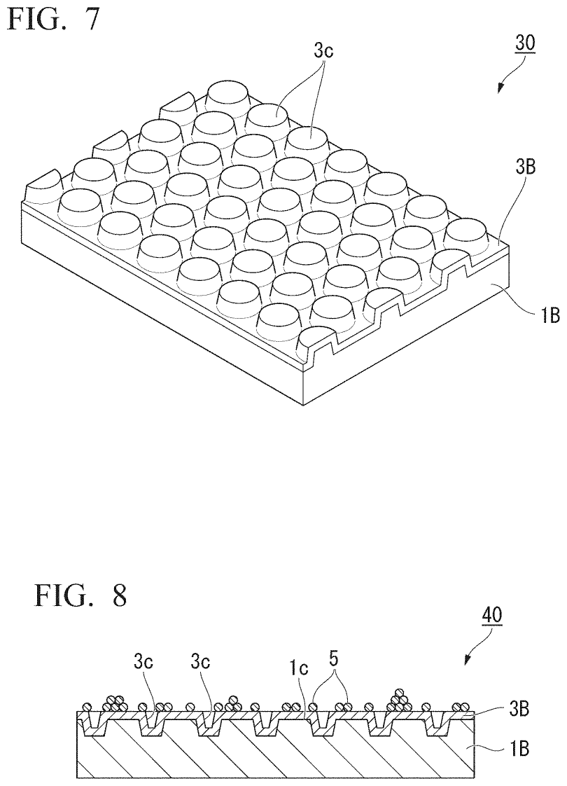

FIG. 5 is a cross-sectional view schematically showing an analysis substrate according to a third embodiment of the present invention, FIG. 6 is a top view schematically showing an analysis substrate according to an example of the present embodiment, and FIG. 7 is a perspective view of the analysis substrate shown in FIG. 6. An analysis substrate 30 of the present embodiment includes a substrate 1B and a metal film 3B provided on a first surface 1c of the substrate 1B. The first surface 1c of the substrate 1B has a periodic uneven structure. Therefore, the surface of the metal film 3B provided on the first surface 1c also has a periodic uneven structure.

(Substrate)

The substrate 1B is the same as the substrate 1 in the first embodiment except that the first surface 1c has a periodic uneven structure.

The periodic uneven structure of the first surface 1c is for providing a periodic uneven structure on the surface of the metal film 3B, and is set according to a desired periodic uneven structure on the surface of the metal film 3B.

The thickness of the substrate 1B is measured by a general caliper measurement method defined in JIS B7507.

(Metal Film)

The metal film 3B is the same as the metal film 3 in the first embodiment except that it has a periodic uneven structure that conforms to the first surface 1c of the substrate 1B.

Here, “conform” means that the position of the convex part or concave part in the periodic uneven structure on the surface of the metal film 3B is substantially the same as the position of the convex part or concave part in the periodic uneven structure of the first surface 1c of the substrate 1B.

Since the surface of the metal film 3B which is a continuous film has a periodic uneven structure, electric field enhancement due to propagation type surface plasmon resonance can occur on the surface of the metal film 3B.

A propagation type surface plasmon on a metal surface is a compression wave of free electrons generated by light (excitation light such as a laser beam used in the Raman spectroscopic method) incident on the metal surface generated by a surface electromagnetic field. When the metal surface is flat, since the dispersion curve of the surface plasmon present on the metal surface does not intersect with the dispersion linear line of light, propagation type surface plasmon resonances are not induced. When the metal surface has a periodic uneven structure, the dispersion linear line of light (diffracted light) diffracted by the periodic uneven structure intersects with the dispersion curve of the surface plasmon, and propagation type surface plasmon resonances are induced.

Here, the “periodic uneven structure” is a structure in which a plurality of convex parts or concave parts are periodically arranged one-dimensionally or two-dimensionally. One-dimensional arrangement means that the direction in which a plurality of convex parts or concave parts are arranged is one direction. Two-dimensional arrangement means that the direction in which a plurality of convex parts or concave parts are arranged is at least two directions in the same plane.

Examples of a structure in which a plurality of convex parts or concave parts are periodically arranged one-dimensionally (one-dimensional lattice structure) include a structure in which a plurality of grooves (concave parts) or projections (convex parts) are arranged in parallel (line and space structure). The shape of the cross section orthogonal to a direction in which grooves or projections extend may be, for example, a polygonal shape such as a triangle, a rectangle, and a trapezoid, a U shape, or a derived shape based on these.

Examples of a structure in which a plurality of convex parts or concave parts are periodically arranged two-dimensionally (two-dimensional lattice structure) include a square lattice structure in which the arrangement directions are two directions and the intersection angle is 90° and a triangular lattice structure in which the arrangement directions are three directions and the intersection angle is 60° (also referred to as a hexagonal lattice). The shape of the convex part constituting a two-dimensional lattice structure may be, for example, a cylinder shape, a cone shape, a truncated cone shape, a sine wave shape, a hemisphere shape, a substantially hemisphere shape, an ellipsoid shape, or a derived shape based on these. The shape of the concave part constituting a two-dimensional lattice structure may be, for example, a shape obtained by inverting the shape of the convex part described above.

Since there are many conditions in which diffracted light can be obtained and propagation type surface plasmon resonance can be induced with high efficiency when there are many arrangement directions, regarding the periodic uneven structure, the two-dimensional lattice structure such as a square lattice structure and a triangular lattice structure is preferable and the triangular lattice structure is more preferable.

As shown in FIGS. 6 and 7, the periodic uneven structure on the surface of the metal film 3B according to an example of the present embodiment is a triangular lattice structure composed of a plurality of convex parts 3c having a truncated cone shape.

The height of the convex part 3c is preferably 15 to 150 nm and more preferably 30 to 80 nm. When the height of the convex part 3c is equal to or higher than the lower limit value in the above range, the periodic uneven structure on the surface of the metal film 3B can sufficiently function as a diffraction lattice and propagation type surface plasmon resonance can be induced. When the height of the convex part 3c is equal to or lower than the upper limit value in the above range, the metal film 3B is likely to be a continuous film.

Even if the convex part 3c has another shape, the preferable height is approximately the same. When the periodic uneven structure on the surface of the metal film 3B is composed of a plurality of concave parts, the preferable depth of the concave part is approximately the same as the preferable height of the convex part 3c. Exactly, the optimal value of the height of the convex part 3c is determined by the volume fraction or dielectric constant of the convex part 3c that interacts with the electromagnetic field due to a surface plasmon.

The height of the convex part 3c is obtained by measuring a distance in a vertical direction to an average value of top surfaces of truncated cones of three convex parts using a center point equidistant from three adjacent convex parts as a starting point using an atomic force microscope (AFM) or the like. For measurement, a periodic uneven structure surface in which there are five points that are separated from each other by 100 μm or more is used. 5 μm×5 μm AFM images of these five measurement areas are obtained, and the above three-point center depths of nine randomly extracted parts of the AFM images are measured. Since the AFM probe may cause anisotropy in the image depending on the scanning direction, as shown in FIG. 6, profile images are formed in three directions D_{M1} to D_{M3}, and measurement is performed at three points in each of the directions, for a total of nine measurement points. The average value of the measured values obtained at the nine measurement points is set as a measured value of one measurement area, a measured value of five measurement areas is obtained in the same manner, and additionally, the average of the measured values of the five measurement areas is obtained and used as the height of the convex part 3c.

On the main surface of the metal film 3B, D_{M1} to D_{M3} are directions substantially orthogonal to each of the three arrangement directions E_{M1} to E_{M3} of the convex part 3c (they are not always orthogonal because the actual lattice arrangement has some distortion).

The height of the convex parts and the depth of the concave parts having other shapes are measured by the same measurement method.

The pitch Λ of the convex parts 3c in the arrangement direction of the convex parts 3c is designed to correspond to the wavelength λᵢ of incident light (excitation light). When the wave number of incident light is kᵢ(kᵢ=2π/λᵢ), the real part of the relative dielectric constant of the metal at kᵢ is εᵢ, and the real part of the relative dielectric constant of the specimen is ε₂, the wave number kₛₚₚ of the surface plasmon is by the following Formula 1 in a simplified manner:

kₛₚₚ=kᵢ((ε₁×ε₂)/(ε₁+ε₂))^{0.5} (Formula 1)

The wavelength λₛₚₚ of the surface plasmon is a reciprocal of kₛₚₚ, and the convex part 3c has a triangular lattice arrangement, and thus the pitch Λ of the convex part 3c is obtained by the following Formula 2:

Λ=(2/√3)×λₛₚₚ (Formula 2)

Formula 1 and Formula 2 are general.

According to the above calculation method, for example, when the wavelength λᵢ of incident light is 785 nm, the metal constituting the convex part 3c is gold (Au), and the specimen is an aqueous solution (ε₂≈1.33),

kₛₚₚ=11.8 μm⁻¹, Λ=655 nm

Similarly, for example, when the wavelength λᵢ of incident light is 633 nm, the metal constituting the convex part 3c is gold (Au), and the specimen is a dried organic component (ε₂≈2.25),

kₛₚₚ=16.6 μm⁻¹, Λ=438 nm

When a laser beam is used as incident light, since the wavelength distribution is extremely narrow, the convex part 3c may be formed substantially as close as possible to the pitch Λ. In addition, when the two-dimensional lattice arrangement is a square lattice or in the case of one-dimensional lattice arrangement (line & space), the following Formula 3 may be used in place of Formula 2.

Λ=λₛₚₚ (Formula 3)

A laser light source used for incident light supports various wavelengths such as 785, 633, 532, 515, 488, and 470 nm. Generally, regarding a metal species constituting a sea-island structure, metal nanoparticles, or a periodic uneven structure, gold (Au) is preferably used for a light source having a wavelength larger than about 500 nm, silver (Ag) is preferably used for a light source having a wavelength smaller than about 500 mu, but a surface enhanced Raman scattering effect may be obtained with a metal species other than gold (Au) and silver (Ag), and the metal species is not necessarily limited to the above.

Even if the convex part 3c has another shape, the preferable pitch is the same as above. When the periodic uneven structure on the surface of the metal film 3B is composed of a plurality of concave parts, the preferable pitch of concave parts in the concave part arrangement direction is the same as the preferable pitch of the convex parts 3c.

The pitch of the convex parts 3c is obtained by measuring the distance in the horizontal direction between center points of two adjacent truncated cone protrusions using an atomic force microscope (AFM) or the like. For measurement, a periodic uneven structure surface in which there are five points that are separated from each other by 100 μm or more is used. 5 μm×5 μm AFM images of these five measurement areas are obtained, and the distance between the above two points of nine randomly extracted parts of the AFM images are measured. Since the AFM probe may cause anisotropy in the image depending on the scanning direction, as shown in FIG. 6, profile images are formed in three directions E_{M1} to E_{M3}, and measurement is performed at three points in each of the directions, for a total of nine measurement points. The average value of the measured values obtained at the nine measurement points is set as a measured value of one measurement area, and additionally, an average of the measured values of the five measurement areas is obtained and used as the pitch of the convex parts 3c.

The pitch of the convex parts and the pitch of the concave parts having other shapes are measured by the same measurement method.

(Method of Producing Analysis Substrate)

Examples of a method of producing the analysis substrate 30 include the following production method (III).

Production Method (III):

A method of producing an analysis substrate including a process of depositing a metal on the first surface 1c of the substrate 1B to form the metal film 3B, and in the process of forming the metal film 3B, when a plurality of areas in which no metal is deposited remain on the first surface 1c in an island shape, and the sheet resistance of the surface of the metal film 3B is 3 to 5,000Ω/□, deposition of the metal on the first surface 1c ends.

The process of forming the metal film 3B is the same as the process of forming the metal film 3 in the first embodiment except that the substrate 1B is used in place of the substrate 1, and the preferable embodiment is also the same.

Regarding the substrate 1B, an original plate in which a periodic uneven structure is formed on the surface or its transfer product can be used. Regarding such an original plate or its transfer product, those produced by a known production method may be used or commercially available products may be used.

The original plate is obtained by forming a periodic uneven structure on the surface of the original plate.

The original plate is the same as the substrate 1B except that there is no predetermined periodic uneven structure on the surface.

Regarding a method of forming a periodic uneven structure on the surface of the original plate, for example, a dry etching method using a single particle film as an etching mask (a colloidal lithography method), an electron beam lithography method, a mechanical cutting and processing method, a laser thermal lithography method, an interference exposure method, and more specifically, a two-beam interference exposure method, a reduction exposure method, an alumina anodic oxidation method, and a nanoimprint method from a transfer original plate having a periodic uneven structure on the surface produced by any of these methods are exemplary examples.

Regarding a method of forming a periodic uneven structure, various methods can be applied, and examples thereof include a photolithography method in which electron beam lithography and dry etching are combined, a nanoporous alumina anodic oxidation method, and a nanoimprint method using a master according to the method. Here, the dry etching method (a colloidal lithography method) in which a single particle film is used as an etching mask is preferable because it is possible to produce a fine structure having a large area at low costs. In addition, the colloidal lithography method has an advantage that a plurality of types of structures having different pitches can be easily produced and structure optimization and functional verification can be performed quickly.

The substrate 1B can be produced according to a colloidal lithography method, and more specifically, according to a production method including a process of arranging a single particle film on an original plate (a substrate before a periodic uneven structure is formed on the surface) (single particle film arranging process) and a process of dry etching the single particle film and the original plate (dry etching process).

Hereinafter, the single particle film and the processes will be described in more detail.

<Single Particle Film>

A “single particle film” is a single layer film in which a plurality of particles are two-dimensionally arranged.

The material of the particles constituting the single particle film is not particularly limited, and may be an organic material, an inorganic material, or a composite material including an organic material and an inorganic material.

Examples of organic materials include a thermoplastic resin such as polystyrene and polymethylmethacrylate (PMMA); and a thermosetting resin such as a phenolic resin and an epoxy resin.

Examples of inorganic materials include carbon allotrope, inorganic carbide, inorganic oxide, inorganic nitride, inorganic boride, inorganic sulfide, and inorganic selenide. Examples of carbon allotropes include diamond, graphite, and fullerenes. Examples of inorganic carbides include silicon carbide and boron carbide. Examples of inorganic oxides include silicon oxide, aluminum oxide, zirconium oxide, titanium oxide, cerium oxide, zinc oxide, tin oxide, and yttrium aluminum garnet (YAG). Examples of inorganic nitrides include silicon nitride, aluminum nitride and boron nitride. Examples of inorganic borides include ZrB₂ and CrB₂. Examples of inorganic sulfides include zinc sulfide, calcium sulfide, cadmium sulfide, and strontium sulfide. Examples of inorganic selenides include zinc selenide and cadmium selenide.

The materials constituting the particles may be of one type or two or more types.

The average particle diameter of the particles constituting the single particle film corresponds to the pitch of the periodic uneven structure calculated by the above method according to the excitation wavelength used for spectroscopic analysis. When the average particle diameter of the particles is the calculated value, a propagation type surface plasmon is easily induced.

The average particle diameter of the particles in a slurry state that do not constitute the single particle film is an average primary particle diameter that can be obtained by a general method from a peak obtained by fitting a particle diameter distribution obtained by a particle dynamic light scattering method to a Gaussian curve.

When a periodic uneven structure having a triangular lattice structure shown in FIG. 6 is formed, the coefficient of variation (a value obtained by dividing a standard deviation by an average value) in the particle diameter of particles constituting the single particle film is preferably 20% or less, more preferably 10% or less, and still more preferably 5% or less. In this manner, when particles having a small coefficient of variation in the particle diameter, that is, particles having a small variation in the particle diameter, are used, defective parts in which there are no particles are unlikely to occur in the formed single particle film, and it is possible to obtain a single particle film having a particle arrangement deviation D of 10% or less with high accuracy. In the single particle film having an arrangement deviation D of 10% or less, the particles are two-dimensionally most densely filled, the interval between particles is controlled, and the arrangement accuracy is high. Therefore, when such a single particle film is arranged on an original plate and dry etching is performed, a periodic uneven structure can be formed on the surface of the original plate with high accuracy.

However, the present invention is not limited thereto, and a single particle film may be composed of particles having a large coefficient of variation in the particle diameter. For example, a single particle film may be composed of a mixture of a plurality of particle groups having different average particle diameters.

The particle arrangement deviation D is defined by the following Formula (1).

D[%]=|B−A|×100/A (1)

In Formula (1), A indicates an average particle diameter of particles constituting the single particle film, and B indicates an average pitch between particles in the single particle film. In addition, |B−A| indicates an absolute value of the difference between A and B.

Here, the average particle diameter of the particles is defined as above.

The pitch between particles is the distance between vertices of two adjacent particles, and the average pitch is an average of these. Here, when particles are spherical, a distance between vertices of two adjacent particles is equal to the distance between centers of two adjacent particles.

Specifically, an average pitch B between particles in the single particle film is obtained as follows.

First, an atomic force microscope image or a scanning electron microscope image is obtained for an area that is randomly selected in the single particle film, which is a square area having a repeating unit of 30 to 40 wavelengths with one side having a fine structure. For example, in the case of a single particle film using particles having a particle diameter of 300 nm, an image having an area of 9 μm×9 μm to 12 μm×12 μm is obtained. Then, the waveform of this image is separated by two-dimensional Fourier transform to obtain a fast Fourier transform image (FFT image). Then, a distance from the 0th-order peak to the 1st-order peak in the profile of the FFT image is obtained. The reciprocal of the distance obtained in this manner is an average pitch B₁ in the area. Such processing is similarly performed on a total of 25 or more randomly selected areas having the same area, and average pitches B₁ to B₂₅ in the areas are obtained. The average value of the average pitches B₁ to B₂₅ in the 25 or more areas obtained in this manner is an average pitch B in Formula (1). Here, in this case, the areas that are separated by at least 1 mm are preferably selected, and the areas that are separated by 5 mm to 1 cm are more preferably selected.

In addition, in this case, it is possible to evaluate a variation in the pitch between particles in each image from the half-value width of the 1st-order peak in the profile of the FFT image.

<Single Particle Film Arranging Process>

The single particle film arranging process is preferably performed by a Langmuir-Blodgett method (LB method). In a combination of accuracy of a single layer, ease of operation, support for a large area, reproducibility and the like, this method is extremely superior to, for example, a liquid thin film method described in Nature, Vol. 361, 7 January, 26 (1993) and the like and a so-called particle adsorption method described in Japanese Unexamined Patent Application, First Publication No. S58-120255 and the like and can also be applied for industrial production levels.

For example, a water tank (trough) containing water as a liquid (hereinafter referred to as a lower layer liquid in some cases) for spreading particles on the liquid surface is prepared, and a method including a process in which a dispersion solution in which particles are dispersed in an organic solvent having a smaller specific gravity than water is added dropwise to the liquid surface (dropwise addition process), a process in which the organic solvent is volatilized to form a single particle film composed of particles (single particle film forming process), and a process in which the formed single particle film is transferred to the original plate (transfer process) can be performed for the single particle film arranging process according to the LB method. After the transfer process, a process of fixing the single particle film transferred to the substrate to the substrate (fixing process) may be performed.

In this case, regarding the particles, particles having a hydrophobic surface are used so that the particles are not submerged under the liquid surface of a hydrophilic lower layer liquid. In addition, regarding the organic solvent, a hydrophobic solvent is selected so that, when the dispersion solution is added dropwise to the liquid surface of the lower layer liquid, the dispersion solution does not mix with the lower layer liquid, and spreads at a gas-liquid interface between air and the lower layer liquid.

In addition, here, while an example in which particles having a hydrophobic surface and a hydrophobic solvent as an organic solvent are selected and a hydrophilic liquid is used as a lower layer liquid is an exemplary example, particles having a hydrophilic surface and a hydrophilic solvent as an organic solvent may be selected, and a hydrophobic liquid may be used as a lower layer liquid.

Hereinafter, the dispersion solution used and the processes will be described in detail.

“Dispersion Solution”

The organic solvent used in the dispersion solution is a hydrophobic solvent having a smaller specific gravity than water. It is important for the organic solvent to have high volatility. Regarding an hydrophobic organic solvent having a smaller specific gravity than water and high volatility, for example, volatile organic solvents composed of one or more of chloroform, methanol (used as a mixing material), ethanol (used as a mixing material), isopropanol (used as a mixing material), acetone (used as a mixing material), methyl ethyl ketone, diethyl ketone, toluene, hexane, cyclohexane, ethyl acetate, butyl acetate, and the like are exemplary examples.

Regarding the particles having a hydrophobic surface, among the particles provided as exemplary examples above, those made of an organic material such as polystyrene and having an originally hydrophobic surface may be used, or particles having a hydrophilic surface which are made hydrophobic using a hydrophobic agent may be used.

Regarding the hydrophobic agent, for example, a surfactant, a metal alkoxide, or the like can be used.

A method in which a surfactant is used as a hydrophobic agent is effective for hydrophobizing a wide range of materials, and is suitable when particles are made of an inorganic oxide or the like.

A method in which a metal alkoxide is used as a hydrophobic agent is effective for hydrophobizing particles of an inorganic oxide such as aluminum oxide, silicon oxide, and titanium oxide. In addition, the method can also be applied to particles having a hydroxyl group on the surface in addition to the inorganic oxide particles.

Regarding the surfactant, a cationic surfactant such as hexadecyl trimethyl ammonium bromide, and decyltrimethyl ammonium bromide and an anionic surfactant such as sodium dodecyl sulfate, and sodium 4-octylbenzenesulfonate can be suitably used. In addition, alkanethiol, a disulfide compound, tetradecanoic acid, octadecanoic acid and the like can be used.

Examples of metal alkoxides include alkoxy silane.

Examples of alkoxy silanes include monomethyltrimethoxysilane, monomethyltriethoxysilane, dimethyldiethoxysilane, phenyltriethoxysilane, hexyltrimethoxysilane, decyltrimethoxysilane, vinyltrichlorosilane, vinyltrimethoxysilane, vinyltriethoxysilane, 2-(3,4-epoxycyclohexyl)ethyltrimethoxysilane, 3-glycidoxypropyltrimethoxysilane, 3-glycidoxypropylmethyldiethoxysilane, 3-glycidoxypropyltriethoxysilane, p-styryltrimethoxysilane, 3-methacryloxypropylmethyldimethoxysilane, 3-methacryloxypropyltrimethoxysilane, 3-methacryloxypropylmethyldiethoxysilane, 3-methacryloxypropyltriethoxysilane, 3-acryloxypropyltrimethoxysilane, N-2(aminoethyl)3-aminopropylmethyldimethoxysilane, N-2(aminoethyl)3-aminopropyltrimethoxysilane, N-2(aminoethyl)3-aminopropyltriethoxysilane, 3-aminopropyltrimethoxysilane, 3-aminopropyltriethoxysilane, N-phenyl-3-aminopropyltrimethoxysilane, 3-ureidopropyltriethoxysilane, 3-chloropropyltrimethoxysilane, 3-mercaptopropylmethyldimethoxysilane, 3-mercaptopropyltrimethoxysilane, and 3-isocyanatopropyltriethoxysilane.

The hydrophobic treatment using a surfactant may be performed in a liquid by dispersing particles in a liquid such as an organic solvent or water, or may be performed on particles in a dry state.

When the treatment is performed in a liquid, for example, particles to be hydrophobized are added to and dispersed in the above volatile organic solvent, and a surfactant is then mixed to additionally continue dispersion. In this manner, particles are dispersed in advance and a surfactant is then added thereto, and the surface can be made more uniformly hydrophobic. The dispersion solution after such a hydrophobic treatment can be directly used as a dispersion solution for dropwise adding to the liquid surface of the lower layer liquid in the dropwise addition process.

When particles to be hydrophobized are in a water dispersion state, a method in which a surfactant is added to the water dispersion and the surface of the particles in an aqueous phase is subjected to a hydrophobic treatment, and an organic solvent is then added to extract the hydrophobized particles in an oil phase is also effective. The dispersion solution (dispersion solution in which particles are dispersed in an organic solvent) obtained in this manner can be directly used as a dispersion solution for dropwise adding to the liquid surface of the lower layer liquid in the dropwise addition process.

In order to improve the dispersibility of particles in the dispersion solution, it is preferable to appropriately select and combine the type of the organic solvent and the type of the surfactant. When a dispersion solution having high particle dispersibility is used, it is possible to prevent particles from aggregating in clusters, and a single particle film in which the particles are two-dimensionally densely filled is more easily obtained. For example, when chloroform is selected as the organic solvent, it is preferable to use decyltrimethyl ammonium bromide as a surfactant. In addition, a combination of ethanol and sodium dodecyl sulfate, a combination of methanol and sodium 4-octylbenzenesulfonate, a combination of methyl ethyl ketone and octadecanoic acid, and the like is an exemplary example.

A ratio of the particles to be hydrophobized to the surfactant is preferably in a range in which the mass of the surfactant is ⅓ to 1/15 times the mass of the particles to be hydrophobized.

In the case of such a hydrophobic treatment, stirring the dispersion solution in the treatment or emitting ultrasonic waves to the dispersion solution is also effective in improving the particle dispersibility.

In the hydrophobic treatment using metal alkoxide, alkoxy groups bonded to metal atoms in the metal alkoxide are hydrolyzed to generate hydroxyl groups. For example, in the case of alkoxy silane, alkoxysilyl groups are hydrolyzed to generate silanol groups (Si—OH). The generated hydroxyl groups are dehydration-condensed with hydroxyl groups on the surface of the particles and thus hydrophobization occurs. Therefore, a hydrophobic treatment using a metal alkoxide is preferably performed in water. When a hydrophobic treatment is performed in water in this manner, for example, it is preferable to stabilize a dispersion state of the particles before hydrophobization using a dispersant such as a surfactant together, but a combination of the dispersant and the metal alkoxide is appropriately selected because a hydrophobic effect of the metal alkoxide is reduced depending on the type of the dispersant.

Regarding a specific method of hydrophobizing particles with a metal alkoxide, first, the particles are dispersed in water and this is mixed with a metal-alkoxide-containing aqueous solution (an aqueous solution containing a hydrolyzate of the metal alkoxide), and the mixture is reacted for a predetermined time, preferably 6 to 12 hours with appropriately stirring in a range from room temperature to 40° C. When the reaction is caused under such conditions, the reaction proceeds appropriately, and a dispersion solution containing sufficiently hydrophobized particles can be obtained. When the reaction proceeds excessively, silanol groups react with each other, particles bond with each other, the dispersibility of particles in the dispersion solution decreases, and the obtained single particle film is likely to have two or more layers in which particles are partially aggregated in clusters. On the other hand, when the reaction is insufficient, the hydrophobization of the surface of the particles is also insufficient, and there is a problem that particles sediment in water during the following operation of spreading particles on the water surface, and the strength of the obtained single particle film decreases and wrinkle-like defects may occur, which is not preferable.

Among the above alkoxy silanes, an alkoxy silane other than amine-based silanes is hydrolyzed under acidic or alkaline conditions and thus the pH of the dispersion solution needs to be adjusted to be acidic or alkaline during the reaction. A method of adjusting the pH is not limited, and a method of adding an acetic acid aqueous solution having a concentration of 0.1 to 2.0 mass % is preferable because the hydrolysis is promoted and also the silanol group stabilization effect is obtained.

A ratio of the particles to be hydrophobized to the metal alkoxide is preferably in a range in which the mass of the metal alkoxide is ⅓ to 1/100 times the mass of the particles to be hydrophobized.

After the reaction for a predetermined time, one or more of the above volatile organic solvents are added to the dispersion solution, and the particles hydrophobized in water are extracted in an oil phase. In this case, the volume of the organic solvent added is preferably in a range that is 0.3 to 3 times the dispersion solution before the organic solvent is added. In this manner, the obtained dispersion solution (dispersion solution in which particles are dispersed in an organic solvent) can be directly used as a dispersion solution for dropwise adding to the liquid surface of the lower layer liquid in the dropwise addition process.

In such a hydrophobic treatment, in order to improve the dispersibility of particles in the dispersion solution during the treatment, stirring, emitting of ultrasonic waves, and the like are preferably performed. When the dispersibility of particles in the dispersion solution is improved, it is possible to prevent particles from aggregating in clusters, and a single particle film in which the particles are two-dimensionally densely filled is more easily obtained.

“Dropwise Addition Process”

In the dropwise addition process, the above dispersion solution is added dropwise to a liquid surface of the lower layer liquid.

The concentration of particles in the dispersion solution added dropwise to the lower layer liquid is preferably 1 to 10 mass %. In addition, the dropwise addition rate of the dispersion solution is preferably 0.001 to 0.01 mL/sec. When the concentration of the particles in the dispersion solution or the amount of dropwise addition to the dispersion solution is in such a range, the particles are partially aggregated in clusters to form two or more layers, defective parts in which there are no particles occur, a tendency for the pitch between particles to increase is minimized, and a single particle film in which the particles are two-dimensionally densely filled is more easily obtained.

In order to further improve the accuracy of the formed single particle film, the dispersion solution before being added dropwise to the liquid surface is finely filtered with a membrane filter or the like, and aggregated particles (secondary particles composed of a plurality of primary particles) present in the dispersion solution are preferably removed. When fine filtering is performed in advance in this manner, parts in which two or more layers are partially formed or defective parts in which there are no particles are unlikely to occur, and a single particle film with high accuracy is easily obtained. If the formed single particle film has defective parts having a size of about several μm to several tens of μm, specifically, in the transfer process to be described below, even if an LB trough device including a surface pressure sensor configured to measure a surface pressure of a single particle film and a movable barrier that compresses the single particle film in the direction of the liquid surface is used, such defective parts are not detected from a difference in the surface pressure, and it is difficult to obtain a single particle film with high accuracy.

“Single Particle Film Forming Process”

When the dispersion solution is added dropwise to the liquid surface of the lower layer liquid in the dropwise addition process, the solvent as a dispersion medium is volatilized, particles spread in a single layer on the liquid surface of the lower layer liquid, and a single particle film in which the particles are two-dimensionally densely filled can be formed.

The single particle film is formed by self-assembly of particles. The principle is that, when particles aggregate, surface tension acts due to a dispersion medium present between the particles, and as a result, the particles do not exist in a discrete state, the single layer structure densely filled on the liquid surface of the lower layer liquid is automatically formed. In other words, such formation of the single layer structure due to surface tension can be called as mutual adsorption between the particles due to a lateral capillary force. For example, when three spherical particles with the same particle diameter that float on the water surface aggregate and come in contact with each other, surface tension acts so that a total length of the waterline of the particle group is minimized, and the three particles are stabilized in an arrangement based on an equilateral triangle. If the waterline reaches the vertex of the particle group, that is, when the particles are submerged under the liquid surface, such self-assembly does not occur, and no single particle film is formed. Therefore, when one of the particles and the lower layer liquid is hydrophobic, it is important to make the other hydrophilic so that the particle group is not submerged under the liquid surface.

Regarding the lower layer liquid, as described above, water is preferably used, and when water is used, a relatively large surface free energy acts and a single layer structure in which particles once generated are densely filled tends to be stably maintained on the liquid surface.

The single particle film forming process is preferably performed under ultrasonic wave emission conditions. When the single particle film forming process is performed while ultrasonic waves are emitted toward the water surface from the lower layer liquid, mutual adsorption between the particles is promoted, and a single particle film in which the particles are two-dimensionally densely filled with higher accuracy can be obtained.

In this case, the output of ultrasonic waves is preferably 1 to 1,200 W and more preferably 50 to 600 W.

The frequency of ultrasonic waves is not particularly limited, and for example, 28 kHz to 5 MHz is preferable, and 700 kHz to 2 MHz is more preferable. When the frequency is too large, this is not preferable for the LB method because a phenomenon in which energy absorption of water molecules starts and water vapor or water droplets rise from the water surface occurs. When the frequency is too low, the cavitation radius in the lower layer liquid becomes larger, and bubbles are generated in water and float and move toward the water surface. When such bubbles accumulate under the single particle film, this is not preferable for the LB method because the flatness of the water surface is lost.

When ultrasonic waves are emitted, standing waves are generated on the water surface. When the output is too high at any frequency or when the wave height of the water surface is too high depending on tuning conditions of an ultrasonic transducer and a transmitter, it is necessary to be careful because the single particle film is destroyed by the water surface wave.

In consideration of the above, when the frequency of the ultrasonic waves is appropriately set, it is possible to effectively promote dense filling of particles without destroying the single particle film that is being formed. In order to emit ultrasonic waves effectively, it is preferable to use the natural frequency calculated from the particle diameter of particles as a guide. However, when particles have a small particle diameter, for example, 100 nm or less, the natural frequency becomes very high, and thus it is difficult to provide ultrasonic vibration as shown in the calculation result. In such a case, if calculation is performed on the assumption that the natural vibration corresponding to the mass of about the dimer to 20-mer of particles is provided, the required frequency can be reduced to a practical range. Even if ultrasonic vibration corresponding to the natural frequency of the aggregate of particles is applied, the effect of improving a particle filing rate is exhibited. A time for which ultrasonic waves are emitted may be any time as long as it is enough to complete re-arrangement of the particles, and the required time varies depending on the particle diameter, the frequency of ultrasonic waves, the water temperature, and the like. However, general production conditions, 10 seconds to 60 minutes is preferable, and 3 minutes to 30 minutes is more preferable.

Examples of advantages obtained by ultrasonic wave emission include an effect of destroying soft aggregates of particles that easily occur when a nanoparticle dispersion solution is prepared, and an effect of repairing point defects, line defects, or crystal transfers that have occurred once to some extent in addition to dense filling of particles with high accuracy.

“Transfer Process”

In the transfer process, the single particle film formed on the liquid surface in the single particle film forming process, which is in a single layer state, is transferred onto the original plate.

The original plate is the same as the substrate 1B except that no periodic uneven structure is formed on the surface.

A specific method of transferring a single particle film onto an original plate is not particularly limited, and examples thereof include a transfer method in which a hydrophobic original plate that is held substantially in parallel to a single particle film is lowered from above and brought into contact with the single particle film, and the single particle film is adsorption-transferred to the original plate due to the affinity between the hydrophobic single particle film and the original plate; and a method in which an original plate is arranged substantially in a horizontal direction in a lower layer liquid in a water tank in advance before a single particle film is formed, the liquid surface is gradually lowered after the single particle film is formed on the liquid surface, and thus the single particle film is transferred onto the original plate.

According to these methods, the single particle film can be transferred onto the original plate without using a specific device, but a so-called LB trough method is preferably used because a single particle film having a larger area is easily transferred onto the original plate while maintaining the state of the single layer film in which a plurality of particles are two-dimensionally densely filled (refer to Journal of Materials and Chemistry, Vol. 11, 3333 (2001). Journal of Materials and Chemistry, Vol. 12, 3268 (2002), and the like).

In the LB trough method, the original plate is immersed in a lower layer liquid in a water tank in advance substantially in the vertical direction, and in that state, the above dropwise addition process and single particle film forming process are performed to form a single particle film. Then, after the single particle film forming process, the original plate is pulled upward and thus the single particle film can be transferred onto the original plate.

Since the single particle film has already formed into a single layer on the liquid surface of the lower layer liquid in the single particle film forming process, even if a temperature condition (temperature of the lower layer liquid) in the transfer process, a lifting speed of the original plate, and the like are slightly changed, there is no risk of the single particle film collapsing and becoming multiple layers in the transfer process. Here, the temperature of the lower layer liquid generally depends on an environment temperature that varies according to the season and weather and is about 3 to 30° C.

In this case, when an LB trough device including a surface pressure sensor based on the principle of a Wilhelmy plate or the like, which measures a surface pressure of the single particle film and a movable barrier that compresses the single particle film in a direction along the liquid surface is used as the water tank, the single particle film having a larger area can be transferred onto the original plate more stably. According to such a device, while measuring the surface pressure of the single particle film, the single particle film can be compressed to reach a preferable diffusion pressure (density), and can be moved toward the substrate at a certain speed. Therefore, transfer of the single particle film from the liquid surface onto the original plate proceeds smoothly, and problems such as only a single particle film having a small area being able to be transferred onto the original plate are unlikely to occur.

The preferable diffusion pressure is 5 to 80 mNm⁻¹ and more preferably 3 to 40 mNm⁻¹. With such a diffusion pressure, it is easy to obtain a single particle film in which particles are two-dimensionally densely filled with higher accuracy. The rate of pulling up the original plate is preferably 0.5 to 20 mm/min. Here, the LB trough device can be obtained as a commercially available product.

“Fixing Process”

When the fixing process in which the single particle film transferred onto the original plate in the transfer process is fixed to the original plate is performed, in the dry etching process to be described below, it is possible to prevent particles constituting the single particle film from moving on the surface of the original plate and the single particle film from peeling off, and the original plate can be etched more stably with high accuracy.

Examples of a method of the fixing process include a method using a binder and a sintering method.

In the method using a binder, a binder solution is supplied to the surface of the original plate on which the single particle film is formed, and penetrates between the particles constituting the single particle film and the original plate.

Regarding the binder, metal alkoxides provided as exemplary examples above of a hydrophobic agent, general organic binders, inorganic binders, and the like can be used.

The amount of the binder used is preferably 0.001 to 0.02 times the mass of the single particle film. Within such a range, it is possible to fix sufficient particles without causing a problem that the binder is clogged between particles due to an excessive amount of the binder and the accuracy of the single particle film is adversely affected. When a large amount of the binder solution is supplied, after the binder solution has penetrated, a spin coater may be used or the original plate may be tilted to remove the excess binder solution.

After the binder solution has penetrated, a heat treatment may be appropriately performed depending on the type of the binder. When a metal alkoxide is used as a binder, it is preferable to perform a heat treatment under conditions of 40 to 80° C. for 3 to 60 minutes.

When the sintering method is used, the original plate on which the single particle film is formed is heated, and the particles constituting the single particle film may be fused to the original plate.

The heating temperature may be determined according to the material of the particles and the material of the original plate. In the case of particles having a particle diameter of 1 μm or less, since an interfacial reaction starts at a temperature lower than the original melting point of the material constituting the particles, sintering is completed on the relatively low temperature side. When the heating temperature is too high, the fusion area of the particles becomes large, and as a result, the shape of the single particle film may change, which may affect the accuracy.

When heating is performed in air, the original plate and the particles may be oxidized depending on the material. For example, when a silicon substrate is used as an original plate and sintered at 1,100° C., a thermal oxide layer having a thickness of about 200 nm is formed on the surface of the substrate. Therefore, in the dry etching process to be described below, it is necessary to set etching conditions in consideration of the possibility of such oxidation.

<Dry Etching Process>

In the dry etching process, for example, the original plate is dry-etched using the single particle film as an etching mask under conditions in which both the particles and the original plate are substantially etched.

When dry etching is performed in this manner, the particles constituting the single particle film are etched, the particle diameter of the particles gradually decreases, gaps are also formed in parts in which particles are in contact with each other before dry etching, and the particles are not in contact with each other. In addition, an etching gas passes through the gaps between the particles and reaches the surface of the original plate, the surface of the original plate positioned below the gap is etched to form a concave part. Apart covered with particles remains without being etched and this part becomes the convex part 3c. Thereby, the substrate 1B is obtained.

Before the original plate is dry-etched, the particles may be dry-etched under conditions in which the original plate is not substantially etched.

When dry etching conditions, for example, the pressure, the plasma power, the bias power, the type of the etching gas, the flow rate of the etching gas, and the etching time, are adjusted, it is possible to adjust the thickness (occupation volume in the surface layer:filling factor) of the convex part 3c, the height of the convex part 3c (depth of the concave part), and the like.

The etching gas can be appropriately selected from among known etching gas according to the materials of the particles and the substrate and the like so that both the particles and the original plate can be etched.

When the original plate is, for example, glass, and the particles are silica (SiO₂), Ar, SF₆, F₂, CF₄, C₄F₈, C₅F₈, C₂F₆, C₃F₆, C₄F₆, CHF₃, CH₂F₂, CH₃F, C₃F, Cl₂, CCl₄, SiC₄, BCl₂, BCl₃, BC₂, Br₂, Br₃, HBr, CBrF₃, HCl, CH₄, NH₃, O₂, H₂, N₂, CO, CO₂ and the like can be used.

When the original plate is made of quartz and the particles are made of silica, Ar, CF₄ and the like can be used.

When the original plate is made of sapphire and the particles are made of silica, Cl₂, BCl₃, SiCl₄, HBr, HI, HCl, and the like can be used.

The etching gases may be used alone or two or more thereof may be used in combination. The etching conditions can be easily adjusted by adjusting a mixing ratio between two or more etching gases and the like.

The etching gas may be diluted with a gas other than the etching gas.

Dry etching is preferably perfumed by anisotropic etching in which the etching rate in the vertical direction is higher than that in the horizontal direction of the original plate. Regarding an etching device that can be used, specifications such as a plasma generation type, the structure of the electrode, the structure of the chamber, and the frequency of the high frequency power supply are not particularly limited as long as anisotropic etching by a reactive ion etching device, an ion beam etching device, or the like is possible, and a bias electric field of about 20 W at the minimum can be generated,

The etching selection ratio (etching rate of original plate/etching rate of single particle film) in dry etching is not particularly limited, and can be adjusted according to etching conditions (the material of the particles constituting the single particle film, the material of the original plate, the type of the etching gas, the bias power, the antenna power, the gas flow rate, the pressure, the etching time, and the like).

The dry etching of the original plate may be completed when the particles constituting the single particle film disappear or may be completed before the particles disappear.

When the dry etching of the original plate is completed before the particles disappear, the particles remaining on the formed substrate 1B are removed after the dry etching of the original plate.

Examples of a particle removal method include a chemical removal method in which an etchant that has etching properties with respect to particles and has etching resistance with respect to the substrate 1B is used and a physical removal method using a brush roll cleaning machine or the like.

As described above, the original plate is obtained.

A transfer product of the original plate is obtained by transferring a periodic uneven structure on the surface of the original plate once or more to another original plate. When the number of times of transfer is an odd number, a transfer product having a periodic uneven structure having a shape in which the periodic uneven structure on the surface of the original plate is reversed is obtained. When the number of times of transfer is an even number, a transfer product having a periodic uneven structure having the same shape as the periodic uneven structure on the surface of the original plate is obtained.

For example, when the periodic uneven structure on the surface of the original plate is transferred to a mold (die or stamper) (first transfer), and the uneven structure of the mold is then transferred (second transfer), a transfer product having a periodic uneven structure having the same shape as the periodic uneven structure on the surface of the original plate is obtained.

Regarding a method of transferring the uneven structure of the original plate to a mold (die or stamper), for example, an electroforming method disclosed in Japanese Unexamined Patent Application, First Publication No. 2009-158478 is preferable.

Examples of a method of transferring the uneven structure of the mold include a nanoimprint method, a thermal pressing method, an injection molding method, an UV embossing method and the like disclosed in Japanese Unexamined Patent Application, First Publication No. 2009-158478. Among these, the nanoimprint method is suitable for transferring a fine uneven structure.

(Operations and Effects)

When the analysis substrate 30 of the present embodiment is used for spectroscopic measurement, localized surface plasmon resonance due to incident light occurs in the non-deposition areas G of the metal film 3, and a non-linear optical electric field enhancement effect due to superimposition of electric fields can be obtained. In addition, when a periodic uneven structure is provided on the surface of the metal film 3 which is a continuous film, it is possible to obtain the electric field enhancement effect due to propagation type surface plasmon resonance. When localized surface plasmon resonance and propagation type surface plasmon resonance are used in combination, optical analysis using electric field enhancement can be performed with higher sensitivity than in the first embodiment and the second embodiment.

Generally, the propagation type surface plasmon according to the periodic uneven structure has an advantage that an electric field distribution uniformity is more excellent than the localized surface plasmon according to local gaps. On the other hand, when a very narrow local gap is formed, the localized surface plasmon can obtain a stronger electric field enhancement effect than the propagation type surface plasmon. Therefore, when the propagation type surface plasmon and the localized surface plasmon are used in combination, the results obtained by adding the advantages of the above both cases are obtained, and it is possible to provide an analysis base material useful for spectroscopic analysis with high sensitivity.

The analysis substrate 30 also has excellent productivity. For example, as shown in the production method (III), it can be produced by simply depositing a metal on the substrate 1B. In addition, there is no need to use a large amount of metal for forming a structure that can cause electric field enhancement due to localized surface plasmon resonance and raw material cost can be reduced.

According to the above effects, the analysis substrate 30 is useful for optical analysis using the electric field enhancement effect due to surface plasmon resonance. Examples of such an optical analysis method include the same as those described above.

### Fourth Embodiment

FIG. 8 is a cross-sectional view schematically showing an analysis substrate according to a fourth embodiment of the present invention.

An analysis substrate 40 of the present embodiment includes the substrate 1B, the metal film 3B provided on the first surface 1c of the substrate 1B, and the plurality of metal nanoparticles 5 that are distributed and arranged on the metal film 3. The metal film 3B and the plurality of metal nanoparticles 5 are in contact with each other. The analysis substrate 40 is the same as the analysis substrate 30 of the third embodiment except that it further includes the plurality of metal nanoparticles 5.

(Method of Producing Analysis Substrate

Examples of a method of producing the analysis substrate 40 include the following production method (IV).

Production Method (IV):

A method of producing an analysis substrate including a process of depositing a metal on the first surface 1c of the substrate 1B to form the metal film 3B, and a process of applying a metal nano particle dispersion solution containing the plurality of metal nanoparticles 5 and a dispersion medium to the metal film 3B and performing drying, and in the process of forming the metal film 3B, when a plurality of areas in which no metal is deposited on the first surface 1c remain in an island shape, and the sheet resistance of the surface of the metal film 3B is 3 to 5,000Ω/□, deposition of the metal on the first surface 1c ends.

The process of forming the metal film 3B is the same as the process of forming the metal film 3B in the production method (III), and the preferable embodiment is also the same.

The process of applying the metal nano particle dispersion solution to the metal film 3B and performing drying is the same as the process of applying the metal nano particle dispersion solution to the metal film 3 and performing drying in the production method (II).

(Operations and Effects)

When the analysis substrate 40 of the present embodiment is used for spectroscopic measurement, localized surface plasmon resonance due to incident light occurs in the gap in the non-deposition areas G of the metal film 3, between the metal film 3 and the metal nanoparticles 5, and between the adjacent metal nanoparticles 5, and a non-linear optical electric field enhancement effect due to superimposition of electric fields can be obtained. In addition, when a periodic uneven structure is provided on the surface of the metal film 3 which is a continuous film, it is possible to obtain the electric field enhancement effect due to propagation type surface plasmon resonance. When localized surface plasmon resonance in three types of metal gaps and propagation type surface plasmon resonance according to one type of metal lattice structure are used in combination, optical analysis using the electric field enhancement effect can be performed with higher sensitivity than in the first embodiment, the second embodiment, and the third embodiment.

The analysis substrate 40 also has excellent productivity. For example, as shown in the production method (IV), it can be produced by simply depositing a metal on the substrate 1B and additionally applying a metal nano particle dispersion solution and performing drying. In addition, there is no need to use a large amount of metal for forming a structure that can cause electric field enhancement due to localized surface plasmon resonance and raw material cost can be reduced.

According to the above effects, the analysis substrate 40 is useful for optical analysis using electric field enhancement due to surface plasmon resonance. Examples of such an optical analysis method include those described above.

While the present invention has been described above with reference to the embodiments, the present invention is not limited to these embodiments. The configurations in the embodiments and combinations thereof are examples, and additions, omissions, substitutions, and other modifications of the configurations can be made without departing from the spirit and scope of the present invention.

For example, while FIG. 2 shows an example in which the shape of the non-deposition areas G in a top view is a band shape the shape of the non-deposition areas G in a top view is not limited thereto, and may be another shape, for example, a circular shape, a rectangular shape, a tree shape, or an irregular shape.

While an example in which the shape, the size, and the distribution of each of the plurality of non-deposition areas G are random (not constant) is shown, the shape and the size of each of the plurality of non-deposition areas G may be constant. The plurality of non-deposition areas G may be regularly arranged.

FIG. 3 shows an example in which the metal surface 3a surrounding the non-deposition areas G is an inclined surface, but the metal surface 3a may be a non-inclined surface. In addition, the metal surface 3a may be a smooth surface or an irregular surface.

When the metal film is a metal film formed by a method of depositing a metal on a first surface of a substrate (a sputtering method, a vacuum deposition method, or the like), the metal surface surrounding the non-deposition areas G is locally an inclined surface and is an irregular surface in many cases.

In the second embodiment or the fourth embodiment, the metal film 3 may be a metal film in which the sheet resistance on the surface exceeds 5,000Ω/□. The upper limit of the sheet resistance on the surface of the metal film is not particularly limited, and may be a resistance value of less than ∞ (infinity) Ω/□ (∞ (infinity) Ω/□ is not included).

In a metal film having the plurality of non-deposition areas G, when a proportion of the non-deposition areas G increases, the number of divided parts of the deposition area increases, and the sheet resistance of the surface exceeds 5,000Ω/□. When the sheet resistance exceeds 5,000Ω/□, the electric field enhancement effect due to the non-deposition areas G is obtained. However, when the plurality of metal nanoparticles 5 having an average primary particle diameter of 5 to 100 nm are distributed and arranged on the metal film, localized surface plasmon resonance due to incident light occurs between the metal film and the metal nanoparticles, and between adjacent metal nanoparticles, a non-linear optical electric field enhancement effect due to superimposition of electric fields can be obtained, and optical analysis using the electric field enhancement effect can be performed with high sensitivity.

### EXAMPLES

While the present invention will be described below in more detail with reference to examples, the present invention is not limited to such examples.

Measurement methods used in examples are shown below. Here, the methods of measuring the height and pitch of the convex parts of the periodic uneven structure are described above.

(Sheet Resistance of Surface of Metal Film at 25° C.)

The sheet resistance at 25° C. was measured with a resistivity meter (Loresta AX MCP-T370) used for a general continuity test. Since a metal film constituting a metal structure was very thin, in the probe of the resistivity meter, a distance of 1.5 mm between PSP option probe (MCP-TP06P) pins for thin film measurement was used, and a measured value (Ω/□) was obtained as an average value (n=5 or more).

(Distance Between Metal Surfaces Facing Each Other with Non-Deposition Areas G Therebetween)

The metal film 3 had a sea-island structure (composed of islands (voids in the non-deposition areas G) for sea (metal=deposition area) of the sea-island structure) composed of a metal film and non-deposition areas G scattered in the metal film, and the distance between the metal surfaces 3a was measured by the following measurement method.

That is, SEM images of 0.6 μm×0.45 μm areas at a magnification of 200,000 were obtained from five points that were separated from each other by 100 μm or more on the surface of the metal film 3, and measurement of parts of the non-deposition areas G in each of the SEM images was performed. Since the contour was unclear in the SEM image at this magnification in some cases, the contrast of the image was enhanced or light and shade of the image was binarized for ease of measurement using Adobe Photoshop or image processing software having the same functions after the SEM image was obtained. Here, the gap of the part of the non-deposition areas G in the short axis direction was called a nanogap. For measurement of the gap in the nanogap, first two diagonal lines LD were drawn on the SEM image obtained as described above, and the gap width in the short axis direction was measured for all parts of the non-deposition areas G that the diagonal line intersected. The measurement was performed at an intersection at which the diagonal line intersected each of the non-deposition areas G, and specifically, a point P which was ½ of an intersection distance between the diagonal line and a certain non-deposition area G was defined, a linear line L_{G} that divided the non-deposition area G into two was drawn at the shortest distance while passing through the point P, and finally a distance I_{G} by which the linear line L_{G} passed through the non-deposition area G was measured. The measurement of I_{G} was performed on the SEM image at the above five points, and the average value of the all measured values was determined as an average value I_{GAVE} of the nanogaps in the non-deposition area G. This average value I_{GAVE} is the distance between the metal surfaces 3a.

(Thickness of Metal Film (Average Thickness of Deposition Area))

The thickness of the metal film 3 (average thickness of the deposition area) was measured by the above method. That is, a very fine scratch (scratch) was formed on the metal film 3 formed on the substrate with a sharp knife tip, and an area including the scratch was measured using a stylus profilometer (fine shape measuring machine ET4000A, commercially available from Kosaka Laboratory Ltd.), and the average thickness of the metal film 3 was measured according to a method of obtaining an average height difference between the bottom surface (part in which the substrate was exposed) of the scratch and the surface of the metal film 3.

Here, while the stylus profilometer was used in the example, even if an atomic force microscope (AFM) image was obtained, similarly, the average height difference between the part in which the substrate was exposed and the surface of the metal film 3 was obtained, it was possible to obtain the same results.

(Average Primary Particle Diameter of Metal Nanoparticles)

The average primary particle diameter of metal nanoparticles was measured by the above method. That is, the surface of the analysis substrate was observed at a magnification of 200,000 using the SEM, the primary particle diameter of the metal nanoparticles was measured, an average value (n=20) was calculated, and this value was determined as the average primary particle diameter.

(Shortest Distance Between Two Adjacent Metal Nanoparticles)

The shortest distance between two adjacent metal nanoparticles is measured by the above method. That is, the surface of the analysis substrate was observed at a magnification of 200,000 using the SEM, the gap between two adjacent metal nanoparticles in the image was actually measured, the average value (n=20) was calculated, and this value was determined as the shortest distance.

(Measurement of Raman Scattering Intensity)

5 μL of a 4,4′-bipyridyl aqueous solution with a concentration of 100 μm was added dropwise to the surface (surface on which the metal film, metal nanoparticles, and the like were provided) of the analysis substrate, and Raman spectrums were measured using a Raman spectrophotometer (Almega XR, commercially available from Thermo Fisher Scientific). A laser beam with an excitation wavelength of 780 nm and an output of 10 mW was used as a light source, and the measured values were compared at an intensity of a detection peak 1,607 cm⁻¹. In Raman conditions, the laser output was 100%, the aperture was a pinhole with a diameter of 100 μm, and the number of exposures was 64.

### Example 1

An analysis substrate having the same configuration as the analysis substrate 10 of the first embodiment was produced by the following procedures.

A sputtering device (ion sputtering device E-1030, commercially available from Hitachi High-Technologies Corporation) was used, and an Au thin film with a thickness of 5.8 nm was formed on a clean and flat quartz substrate at a pressure of 6 to 8 Pa, a current value of 15 mA, and a film formation rate of 11.6 nm/min.

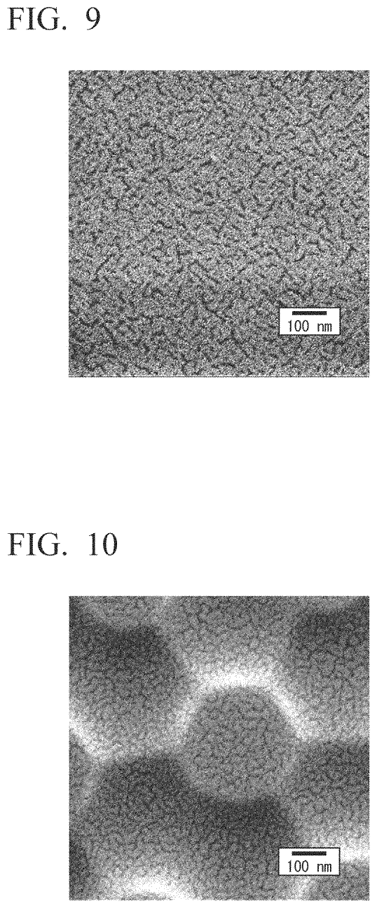

FIG. 9 shows the SEM image of the obtained analysis substrate.

### Example 2

An analysis substrate having the same configuration as the analysis substrate 20 of the second embodiment was produced by the following procedures.

A sputtering device (ion sputtering device E-1030, commercially available from Hitachi High-Technologies Corporation) was used, and an Au thin film with a thickness of 5.8 nm was formed on a clean and flat quartz substrate at a pressure of 6 to 8 Pa, a current value of 15 mA, and a film formation rate of 11.6 nm/min. Then, a process in which an Au nanoparticle dispersion solution (average primary particle diameter of 20.7 nm) was sprayed and applied to the Au thin film and dried was repeated three times, and thus the Au nanoparticles were distributed and arranged on the substrate.

### Example 3

An analysis substrate having the same configuration as the analysis substrate 30 of the third embodiment was produced by the following procedures.

A single layer of colloidal silica particles having an average particle diameter of 600 nm was coated on a quartz substrate according to the LB method described below. First, N-phenyl-3-aminopropyltrimethoxysilane as a hydrophobic agent was added to the silica particle slurry, and the mixture was hydrophobized at a reaction temperature of 40° C. Then, a mixed solvent of ethanol:chloroform=30:70 was used and the hydrophobized silica particles were subjected to oil layer extraction. Next, the hydrophobized particle slurry was added dropwise to the water surface of lower layer water at 21° C. and a pH of 7.2, and a particle single layer film was formed on the water surface. In addition, while compressing the particle single layer film with a barrier, a clean and flat quartz substrate immersed in advance in water was gradually pulled up at 5 mm/min, and the particle single layer film on the water surface was transferred onto the quartz substrate. Then, a dry etching device (ME510I commercially available from Tokyo Electron Ltd.) was used and dry etching was performed under conditions of 1.2 Pa, 2,000/1,800 W, Cl₂=80 sccm, and 100 sec, and a periodic uneven structure having a structural period (pitch) of 600 nm, and a structure height (a vertical distance from the center point of three particles to the top of the structure) of 52 nm was obtained. In addition, a sputtering device (ion sputtering device E-1030, commercially available from Hitachi High-Technologies Corporation) was used, and an Au thin film with a thickness of 5.8 nm was formed on the periodic uneven structure at a pressure of 6 to 8 Pa, a current value of 15 mA, and a film formation rate of 11.6 nm/min. FIG. 10 shows the SEM image of the obtained analysis substrate.

### Example 4

An analysis substrate having the same configuration as the analysis substrate 40 of the fourth embodiment was produced by the following procedures.

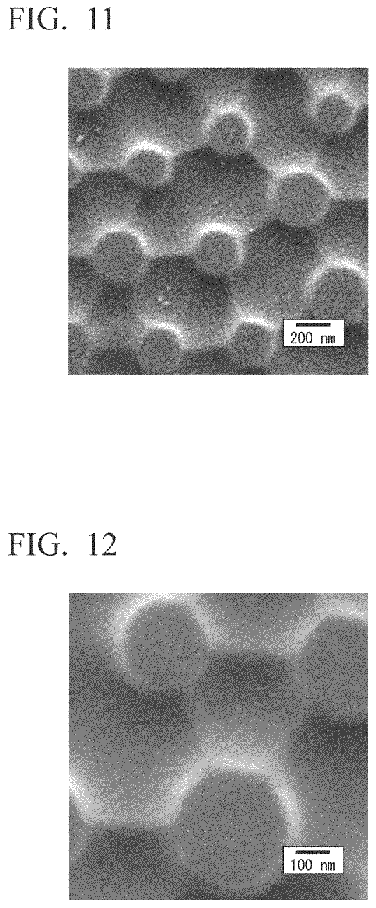

A single layer of colloidal silica particles having an average particle diameter of 600 nm was coated on a quartz substrate according to the LB method described below. First, N-phenyl-3-aminopropyltrimethoxysilane as a hydrophobic agent was added to the silica particle slurry, and the mixture was hydrophobized at a reaction temperature of 40° C. Then, a mixed solvent of ethanol:chloroform=30:70 was used and the hydrophobized silica particles were subjected to oil layer extraction. Next, the hydrophobized particle slurry was added dropwise to the water surface of lower layer water at 21° C. and a pH of 7.2, and a particle single layer film was formed on the water surface. In addition, while compressing the particle single layer film with a barrier, a clean and flat quartz substrate immersed in advance in water was gradually pulled up at 5 mm/min, and the particle single layer film on the water surface was transferred onto the quartz substrate. Then, a dry etching device (ME510I commercially available from Tokyo Electron Ltd.) was used and dry etching was performed under conditions of 1.2 Pa, 2,000/1,800 W, Cl₂=80 sccm, and 100 sec, and a periodic uneven structure having a structural period (pitch) of 600 nm, and a structure height (a vertical distance from the center point of three particles to the top of the structure) of 52 nm was obtained. In addition, a sputtering device (ion sputtering device E-1030, commercially available from Hitachi High-Technologies Corporation) was used, and an Au thin film with a thickness of 5.8 nm was formed on the periodic uneven structure at a pressure of 6 to 8 Pa, a current value of 15 mA, and a film formation rate of 11.6 nm/min. Finally, a process in which an Au nanoparticle dispersion solution (average primary particle diameter of 20.7 nm) was sprayed and applied to the Au thin film and dried was repeated three times, and thus the Au nanoparticles were distributed and arranged on the substrate at the same dispersion density as in Example 2. FIG. 11 shows the SEM image of the obtained analysis substrate.

### Comparative Example 1

A flat quartz substrate having a clean surface with nothing attached thereto, neither metal film nor metal particles, was prepared.

### Comparative Example 2

A flat quartz substrate having a clean surface with nothing attached thereto, neither metal film nor metal particles, was prepared. Then, a process in which an Au nanoparticle dispersion solution (average primary particle diameter of 20.7 nm) was sprayed and applied to the substrate and dried was repeated three times, and thus the Au nanoparticles were distributed and arranged on the substrate at the same dispersion density as in Example 2 and Example 4.

### Comparative Example 3

A single layer of colloidal silica particles having an average particle diameter of 600 nm was coated on a quartz substrate according to the LB method described below. First, N-phenyl-3-aminopropyltrimethoxysilane as a hydrophobic agent was added to the silica particle slurry, and the mixture was hydrophobized at a reaction temperature of 40° C. Then, a mixed solvent of ethanol:chloroform=30:70 was used and the hydrophobized silica particles were subjected to oil layer extraction. Next, the hydrophobized particle slurry was added dropwise to the water surface of lower layer water at 21° C. and a pH of 7.2, and a particle single layer film was formed on the water surface. In addition, while compressing the particle single layer film with a barrier, a clean and flat quartz substrate immersed in advance in water was gradually pulled up at 5 mm/min, and the particle single layer film on the water surface was transferred onto the quartz substrate. Then, a dry etching device (ME510I commercially available from Tokyo Electron Ltd.) was used and dry etching was performed under conditions of 1.2 Pa, 2,000/1,800 W, Cl₂=80 sccm, and 10 sec, and a periodic uneven structure having a structural period (pitch) of 600 nm, and a structure height (a vertical distance from the center point of three particles to the top of the structure) of 52 nm was obtained. In addition, a sputtering device (ion sputtering device E-1030, commercially available from Hitachi High-Technologies Corporation) was used, and an Au thin film with a thickness of up to 15.4 nm was formed on the periodic uneven structure at a pressure of 6 to 8 Pa, a current value of 15 mA, and a film formation rate of 11.6 nm/min. FIG. 12 shows the SEM image of the obtained analysis substrate.

The Raman scattering intensity was measured using the analysis substrates of Examples 1 to 4 and Comparative Examples 1 to 3. The results are shown in Table 1.

TABLE 1

| | Comp. | Comp. | Comp. | | | | |
|---|---|---|---|---|---|---|---|
| | Example | Example | Example | Example | Example | Example | Example |
| | 1 | 2 | 3 | 1 | 2 | 3 | 4 |
| Metal film | No | No | Yes | Yes | Yes | Yes | Yes |
| Thickness of metal | — | — | 15.4 | 5.8 | 5.8 | 5.8 | 5.8 |
| film (nm) | | | | | | | |
| Non-deposition area | — | — | No | Yes | Yes | Yes | Yes |
| G of metal film | | | | | | | |
| Sheet resistance of | — | — | 13.5 | 70.2 | 70.7 | 69.2 | 69.8 |
| surface of metal film | | | | | | | |
| at 25° C. (Ω/□) | | | | | | | |
| Average value I_{GAVE} | — | — | — | 11.0 | 10.2 | 10.3 | 9.5 |
| of the nanogap (nm | | | | | | | |
| or less) | | | | | | | |
| Metal nanoparticles | No | Yes | No | No | Yes | No | Yes |
| Average primary | — | 20.7 | — | — | 20.7 | — | 20.7 |
| particle diameter of | | | | | | | |
| metal nanoparticles | | | | | | | |
| (nm) | | | | | | | |
| Shortest distance | — | 10.1 | — | — | 11.4 | — | 10.9 |
| between metal | | | | | | | |
| nanoparticles (nm) | | | | | | | |
| Periodic uneven | No | No | Yes | No | No | Yes | Yes |
| structure | | | | | | | |
| Structural period | — | — | 600 | — | — | 600 | 600 |
| (nm) | | | | | | | |
| Raman scattering | Not | Not | 3,200 | 5,400 | 9,900 | 17,500 | 33,300 |
| intensity | detected | delected | | | | | |
| (Intensity/arb. unit) | | | | | | | |
| (sample | | | | | | | |
| concentration 100 | | | | | | | |
| μm) | | | | | | | |

In the analysis substrates of Comparative Example 1 and Comparative Example 2, no Raman scattering was detected. In addition, in the analysis substrate of Comparative Example 3, no Raman scattering was detected, but the intensity thereof had a value lower than the intensity of all examples.

On the other hand, in the analysis substrates of Examples 1 to 4, Raman scattering at a sample concentration of 100 μm was obtained with a high intensity, and Raman scattering was detected in samples with a low concentration such as a sample concentration of 10 nm.

### REFERENCE SIGNS LIST

1,1B Substrate
1a First surface
3,3B Metal film
5 Metal nanoparticles
10 Analysis substrate
20 Analysis substrate
30 Analysis substrate
40 Analysis substrate
G Non-deposition area

What is claimed is:

1. An analysis substrate comprising a substrate having at least a first surface made of a dielectric or a semiconductor, and a metal film provided on the first surface of the substrate,
wherein the metal film has a plurality of non-deposition areas which are provided as an island-like gap shape having a length of 1 μm or less in a long axis direction in the metal film and in which there is no metal and the first surface is exposed; and
wherein a sheet resistance of a surface of the metal film at 25° C. is 3 to 5,000Ω/□.

2. The analysis substrate according to claim 1, wherein the sheet resistance of the surface of the metal film at 25° C. is 3 to 500Ω/□.

3. The analysis substrate according to claim 1, wherein the sheet resistance of the surface of the metal film at 25° C. is 3 to 300Ω/□.

4. The analysis substrate according to claim 1, further comprising a plurality of metal nanoparticles having an average primary particle diameter of 5 to 100 nm that are distributed and arranged on the metal film.

5. The analysis substrate according to claim 1, wherein the first surface of the substrate has a periodic uneven structure.

6. The analysis substrate according to claim 1,
wherein the first surface of the substrate has a periodic uneven structure, and
wherein a plurality of metal nanoparticles having an average primary particle diameter of 5 to 100 nm are distributed and arranged on the metal film.

7. An analysis substrate comprising a substrate having at least a first surface made of a dielectric or a semiconductor, a metal film provided on the first surface of the substrate, and a plurality of metal nanoparticles which are distributed and arranged on the metal film and have an average primary particle diameter of 5 to 100 nm,
wherein the metal film has a plurality of non-deposition areas which are provided as an island-like gap shape having a length of 1 μm or less in a long axis direction in the metal film and in which there is no metal and the first surface is exposed; and
wherein a sheet resistance of a surface of the metal film at 25° C. exceeds 5,000Ω/□.

8. A method of producing an analysis substrate, comprising
a process of depositing a metal on a first surface of a substrate having at least the first surface made of a dielectric or a semiconductor to form a metal film,
wherein, in the process of forming the metal film, when a plurality of areas in which no metal is deposited remain on the first surface as an island-like gap shape having a length of 1 μm or less in a long axis direction, and a sheet resistance of a surface of the metal film at 25° C. is 3 to 5,000Ω/□, deposition of the metal on the first surface ends.

9. The method of producing an analysis substrate according to claim 8, wherein, when deposition of the metal on the first surface ends, the sheet resistance of the surface of the metal film at 25° C. is 3 to 500Ω/□.

10. The method of producing an analysis substrate according to claim 8, wherein, when deposition of the metal on the first surface ends, the sheet resistance of the surface of the metal film at 25° C. is 3 to 300Ω/□.

11. The method of producing an analysis substrate according to claim 8, wherein the first surface of the substrate has a periodic uneven structure.

12. The method of producing an analysis substrate according to claim 8, further comprising a process of applying a metal nano particle dispersion solution containing a plurality of metal nanoparticles having an average primary particle diameter of 5 to 100 nm and a dispersion medium to the metal film and performing drying.

13. The method of producing an analysis substrate according to claim 8, further comprising
a process of applying a metal nano particle dispersion solution containing a plurality of metal nanoparticles having an average primary particle diameter of 5 to 100 nm and a dispersion medium to the metal film and performing drying,
wherein the first surface of the substrate has a periodic uneven structure.

14. The analysis substrate according to claim 2, further comprising a plurality of metal nanoparticles having an average primary particle diameter of 5 to 100 nm that are distributed and arranged on the metal film.

15. The analysis substrate according to claim 2, wherein the first surface of the substrate has a periodic uneven structure.

16. The analysis substrate according to claim 2,
wherein the first surface of the substrate has a periodic uneven structure, and
wherein a plurality of metal nanoparticles having an average primary particle diameter of 5 to 100 nm are distributed and arranged on the metal film.

17. The analysis substrate according to claim 3, further comprising a plurality of metal nanoparticles having an average primary particle diameter of 5 to 100 nm that are distributed and arranged on the metal film.

18. The analysis substrate according to claim 3, wherein the first surface of the substrate has a periodic uneven structure.

19. The analysis substrate according to claim 3,
wherein the first surface of the substrate has a periodic uneven structure, and
wherein a plurality of metal nanoparticles having an average primary particle diameter of 5 to 100 nm are distributed and arranged on the metal film.

20. The method of producing an analysis substrate according to claim 9, wherein the first surface of the substrate has a periodic uneven structure.
